(19) United States
(12) Patent Application Publication
(10) Pub. No.: US 2022/0030154 A1
(43) Pub. Date: Jan. 27, 2022

(54) Display Device and Electronic Device

(71) Applicant: Semiconductor Energy Laboratory Co., Ltd., Kanagawa-ken (JP)

(72) Inventors: Shunpei YAMAZAKI, Tokyo (JP); Hajime KIMURA, Atsugi (JP)

(73) Assignee: Semiconductor Energy Laboratory Co.,Ltd., Kanagawa-ken (JP)

(21) Appl. No.: 17/499,076

(22) Filed: Oct. 12, 2021

Related U.S. Application Data
(63) Continuation of application No. 14/560,726, filed on Dec. 4, 2014, now abandoned.

(30) Foreign Application Priority Data
Dec. 10, 2013 (JP) 2013-255042

(51) Int. Cl. H04N 5/235; H04N 5/232; G06F 3/0488

(52) U.S. Cl. CPC H04N 5/2354; G06F 2203/04803; G06F 3/04886; H04N 5/23293

(57) ABSTRACT

An object is to provide a display device that makes it easy to photograph a user's face looking at a display screen, or the like, in a dark place. Another object is to provide a display device that makes it easy to check a user's face looking at a display screen, or the like, in a dark place. A display device includes a first region and a second region. The first region has a function of displaying an image of a subject. The second region has a function of illuminating a subject with light. An electronic device includes a display device and an imaging device. The display device includes a first region and a second region. The first region has a function of displaying an image of a subject that is obtained using the imaging device. The second region has a function of illuminating a subject with light.

This application is a continuation of copending U.S. application Ser. No. 14/560,726, filed on Dec. 4, 2014 which is incorporated herein by reference.

### BACKGROUND OF THE INVENTION

### 1. Field of the Invention

One embodiment of the present invention relates to a light source for an imaging device, a display device, or a driving method thereof. One embodiment of the present invention particularly relates to a program for an imaging device or a display device, a record medium where the program is recorded, or an electronic device including the record medium.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a liquid crystal display device, a light-emitting device, a lighting device, a power storage device, a storage device, a method for driving any of them, and a method for manufacturing any of them.

### 2. Description of the Related Art

Electronic devices having a camera function or including imaging elements such as image sensors are developed. In particular, portable electronic devices having a camera function or including imaging elements are actively developed. Such portable electronic devices have large displays on their front surfaces. Users take images and video using an image sensor on the back surface of the electronic device, looking at the large display screen.

Nowadays, electronic devices including image sensors not only on their back surfaces but also on their front surfaces are developed. That is, an image sensor and a display are provided on the same surface, and a user's face looking at the display, or the like is photographed with the image sensor on the front surface of the electronic device (see Patent Document 1). In addition, when the electronic device is used as a video phone, a user can photograph his or her face with the image sensor and send the image to an intended party while viewing an image of the intended party on the display.

Note that the illuminance of a subject is sometimes low in photographing with an image sensor. In this case, the subject is illuminated with light from a light source such as a flash or a strobe to increase the illuminance of the subject, so that the subject can be photographed well (see Patent Document 2). Thus, portable electronic devices often include flashes for illuminating subjects in addition to image sensors. Patent Document 1 discloses an electronic device in which a display portion has a display function and a function of illuminating a subject and these functions can be switched.

### REFERENCE

[Patent Document 1] Japanese Published Patent Application No. 2004-350208
[Patent Document 2] Japanese Published Patent Application No. 2007-110717

### SUMMARY OF THE INVENTION

In an electronic device where a display portion and a camera portion including an image sensor are provided on the same side, the display portion has a display function and a function of illuminating a subject of the camera. In the case where switching to the illuminating function is performed for the display portion before photographing, there is a possibility that how a subject is photographed cannot be accurately checked. In contrast, in the case where switching to the illuminating function is performed for display portion only in a moment of photographing, the illuminance of a subject is low when the luminance of ambient light is low; thus, nothing but the subject that is dark might be seen.

In view of the above, an object of one embodiment of the present invention is to provide a display device, an electronic device, or the like that makes it easy to photograph a user's face looking at a display screen, or the like, in a dark place. Another object of one embodiment of the present invention is to provide a display device, an electronic device, or the like that makes it easy to check a user's face looking at a display screen, or the like, in a dark place.

Another object of one embodiment of the present invention is to provide a display device, an electronic device, or the like that can illuminate a subject with high-luminance illumination light. Another object of one embodiment of the present invention is to provide a display device, an electronic device, or the like that can be used as a light source for a subject. Another object of one embodiment of the present invention is to provide a display device, an electronic device, or the like that can be used for security. Another object of one embodiment of the present invention is a display device, an electronic device, or the like with low power consumption. Another object of one embodiment of the present invention is to provide a novel display device or electronic device. Another object of one embodiment of the present invention is to provide a novel lighting device or the like. Another object of one embodiment of the present invention is to provide a novel program, software, or the like.

Note that the descriptions of these objects do not disturb the existence of other objects. One embodiment of the present invention does not necessarily achieve all the objects. Other objects will be apparent from and can be derived from the description of the specification, the drawings, the claims, and the like.

One embodiment of the present invention is a display device that includes a first region and a second region. The first region has a function of displaying an image of a subject. The second region has a function of illuminating a subject with light.

Another embodiment of the present invention is a display device that includes a first region and a second region. The first region has a function of displaying an image. The second region has a function of emitting illuminating light.

Another embodiment of the present invention is an electronic device that includes a display device and an imaging device. The display device includes a first region and a second region. The first region has a function of displaying an image of a subject that is obtained using the imaging device. The second region has a function of illuminating a subject with light.

Another embodiment of the present invention is the electronic device having the above structure in which the display device and the imaging device are provided on the same surface.

Another embodiment of the present invention is a program having first and second functions. The first function is a function of displaying an image of a subject in a first region of a display device. The second function is a function of displaying an image for illuminating a subject with light in a second region of the display device.

Another embodiment of the present invention is a program having first to third functions. The first function is a function of obtaining an image of a subject with the use of an imaging device. The second function is a function of displaying the image of the subject in a first region of a display device. The third function is a function of displaying an image for illuminating the subject with light in a second region of the display device.

One embodiment of the present invention can provide a display device or the like that enables a user to easily photograph his or her face looking at a display screen, or the like, in a dark place. Another embodiment of the present invention can provide a display device or the like that allows a user to easily check his or her face looking at a display screen, or the like, in a dark place.

Another embodiment of the present invention can provide a display device or the like that can illuminate a subject with high-luminance illuminating light. Another embodiment of the present invention can provide a display device or the like that can be used as a light source for a subject. Another embodiment of the present invention can provide a display device or the like that can be used for security. Another embodiment of the present invention can provide a display device or the like with low power consumption. Another embodiment of the present invention can provide a novel display device or the like. Another embodiment of the present invention can provide a novel lighting device or the like. Another embodiment of the present invention can provide a novel program, software, or the like.

Note that the description of these effects does not disturb the existence of other effects. One embodiment of the present invention does not necessarily have all the effects. Other effects will be apparent from and can be derived from the description of the specification, the drawings, the claims, and the like.

### BRIEF DESCRIPTION OF THE DRAWINGS

In the accompanying drawings:

FIGS. 1A and 1B illustrate an electronic device;

FIG. 2 illustrates an electronic device;

FIG. 3 illustrates an electronic device;

FIG. 4 is a flow chart;

FIG. 5 illustrates an electronic device;

FIG. 6 illustrates an electronic device;

FIGS. 7A and 7B illustrate an electronic device;

FIGS. 8A and 8B illustrate an electronic device;

FIG. 9 illustrates an electronic device;

FIGS. 10A to 10C illustrate an electronic device;

FIGS. 11A to 11C illustrate an electronic device;

FIGS. 12A to 12C illustrate an electronic device;

FIGS. 13A to 13C illustrate an electronic device;

FIGS. 14A and 14B illustrate an electronic device;

FIGS. 15A to 15C illustrate an electronic device;

FIG. 16 illustrates an electronic device;

FIG. 17 illustrates an electronic device;

FIG. 18 illustrates an electronic device;

FIG. 19 illustrates an electronic device;

FIG. 20 illustrates an electronic device;

FIG. 21 illustrates an electronic device;

FIG. 22 illustrates a network structure;

FIGS. 23A and 23B illustrate an electronic device;

FIGS. 24A to 24C illustrates a display device;

FIG. 25 illustrates a display module;

FIGS. 26A to 26C illustrate a structural example of a light-emitting device;

FIGS. 27A to 27C illustrate structural examples of light-emitting devices;

FIGS. 28A to 28C illustrate structural examples of light-emitting devices;

FIGS. 29A to 29C are cross-sectional TEM images and a local Fourier transform image of an oxide semiconductor;

FIGS. 30A and 30B show nanobeam electron diffraction patterns of oxide semiconductor films, and FIGS. 30C and 30D illustrate an example of a transmission electron diffraction measurement apparatus; and

FIG. 31A shows an example of structural analysis by transmission electron diffraction measurement and FIGS. 31B and 31C show plan-view TEM images.

### DETAILED DESCRIPTION OF THE INVENTION

### Embodiment 1

In this embodiment, a driving method of an electronic device of one embodiment of the present invention will be described.

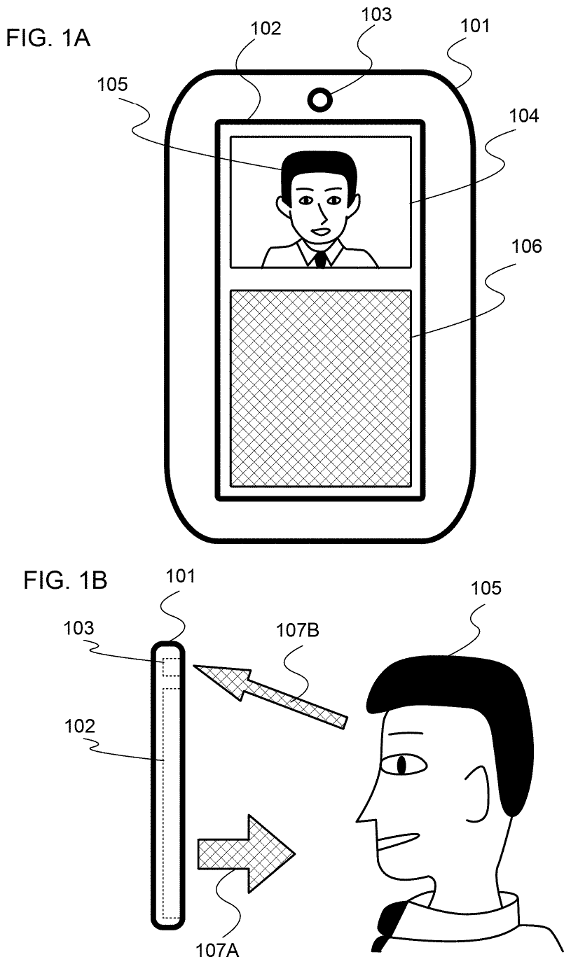

As illustrated in FIG. 1A, a first surface (e.g., the front surface) of an electronic device 101 is provided with a display device 102 and a camera portion 103, for example.

The display device 102 has a function of performing a variety of displays. Alternatively, the display device has a function of outputting light to the outside. Note that the display device can also be referred to as a display portion or a display panel.

The camera portion 103 includes, for example, a lens and an imaging element such as an image sensor and has a function of acquiring an image such as a moving image or a still image. Note that the camera portion can also be referred to as an imaging device.

First, a first mode will be described. This corresponds to the case of performing a normal operation. Thus, the first mode can also be referred to as a first operation mode, a normal mode, a normal operation mode, or the like. In this mode, images, text, photographs, or the like can be viewed or displayed, or text can be input using the display device 102. The input is performed using at least one of a button, a switch, a sensor, and the like provided for the electronic device 101 or using the display device 102 or at least one of a touch sensor, a keyboard, a mouse, various sensors, and the like provided for the display device 102. The display device 102 may thus have a function as an input device. Alternatively, the input is performed using at least one of a keyboard, a mouse, a pointing pad, a button, and a pen connected to the electronic device 101 with or without wires. Still alternatively, the input is performed using at least one of a proximity sensor, an orientation sensor, a magnetic field sensor, a linear acceleration sensor, a luminance sensor, a gyroscope sensor, a gravity sensor, an acceleration sensor, an atmospheric pressure sensor, a temperature sensor, an image sensor, an infrared sensor, a UV sensor, and the like provided for the electronic device 101.

Next, a second mode will be described. This corresponds to, for example, the case of photographing with the use of the camera portion 103 provided on the front surface of the electronic device 101. Thus, the second mode can also be referred to as a second operation mode, a photographing mode, a photographing operation mode, a lighting mode, or a lighting operation mode. In this mode, the display device 102 includes at least a region 104 and a region 106. In the region 104, for example, an image of a subject 105 that is obtained using the camera portion 103 is displayed. That is, the region 104 can have a function as a viewfinder region. The region 106 has a function as a lighting for illuminating the subject 105, for example. In other words, the region 106 can have a function as a flash lighting region. In the second mode, i.e., the photographing mode, the display device 102 has both a lighting function as, for example, a flash or a strobe and a displaying function of displaying an image. The two functions can be implemented while the camera portion 103 is operated. Specifically, the two functions can be performed at one or more of any of the following timings: after photographing is finished, at the same time as a period when a picture is taken by the camera portion 103, at the same time as a period when preparations are made for taking a picture, at the same time as a period when an angle is determined, and the like.

Note that the regions 104 and 106 may be fixed regions, or the sizes, the positions, or the like thereof may be changed as necessary.

It is preferred that one display device include the regions 104 and 106. In that case, at least one of the sizes and the positions of the regions can be freely changed. Note that one embodiment of the present invention is not limited to this example. Different display devices may include the regions 104 and 106; for example, a first display device and a second display device may include the region 104 and the region 106, respectively.

Here, it is preferred that display be performed with substantially even luminance in the region 106, for example. The case of performing display with substantially even luminance corresponds to the case of displaying an image with the same gray level in the region 106. The color of an image with the same gray level is preferably white, in which case a picture of the subject 105 with appropriate colors can be taken. Furthermore, the luminance of the region 106 is preferably as high as possible. The luminance of the region 106 is thus preferably equal to, for example, that when display is performed with the highest gray level in the first mode where a normal operation is performed. Note that one embodiment of the present invention is not limited to these examples. The luminance of the region 106 may be freely set and changed by a user.

FIG. 1B is a schematic side view. Illuminating light 107A is delivered to the subject 105 from the region 106 of the display device 102. The light 107B reflected by the subject 105 enters the camera portion 103. Note that ambient light may illuminate the subject 105, be reflected by the subject 105, and enter the camera portion 103. An image obtained using the camera portion 103 is displayed in the region 104 of the display device 102.

The control of the region 106 and light is performed with the use of one or both of hardware and software. For example, the aforementioned operations are controlled using dedicated software or program as an application for a camera function, whereby the aforementioned operations or functions are implemented. Alternatively, the operations are controlled by some functions of software of an application having certain functions, whereby the above operation or function is implemented.

With such a structure, the subject 105 is illuminated with the illuminating light 107A emitted from the region 106 even when ambient light is dark, so that the subject 105 can be maintained to be illuminated. The camera portion 103 can receive reflected light 107B and thus obtain a clear image. Furthermore, the image obtained using the camera portion 103 is displayed in the region 104 of the display device 102; thus, the taken image can be checked in real time. That is, the subject 105 can check how he or she is photographed, while taking a picture of him or her.

After that, a still image or a moving image is actually taken and the obtained image data is stored in a storage device, a storage medium, or the like. After the photographing, the electronic device 101 returns to the normal mode, and the stored image data can be checked using the display device 102. At this time, the region 106 that serves as lighting is not necessarily provided, since the photographing is finished. In the case where the region 106 is not provided, an image can be checked using the whole display device 102.

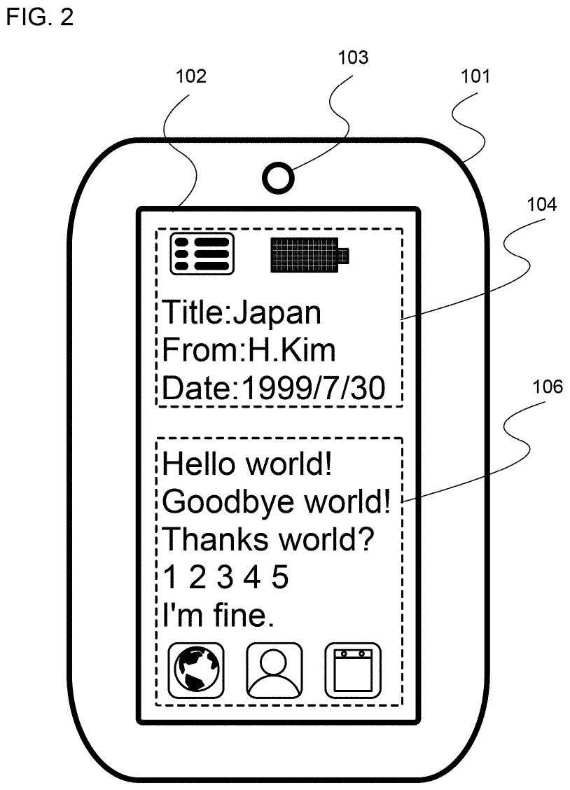

As an example, the case where an e-mail operation is performed in the normal mode is illustrated in FIG. 2.

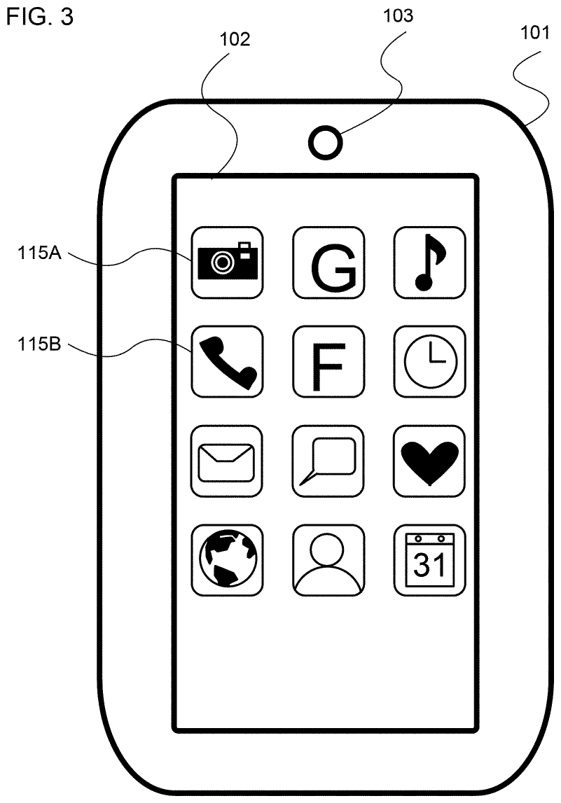

FIG. 3 illustrates an example of a screen of the display device 102 when the electronic device 101 is started. At least one of text, a number, an icon, and the like is displayed on the screen of the display device 102. At least one of text, a number, an icon, and the like is displayed in each of the regions 104 and 106. That is, the regions 104 and 106 each have a function of displaying at least one of text, a number, an icon, and the like depending on an operation mode.

Note that when a moving image is taken by the camera portion 103, for example, it is preferred that the display device 102 include at least the regions 104 and 106, the subject 105 be maintained to be illuminated with the illuminating light 107A in the region 106, and the photographing state continue to be displayed in the region 104. In that case, even a moving image of the subject 105 illuminated appropriately can be taken in an adequate photographing range.

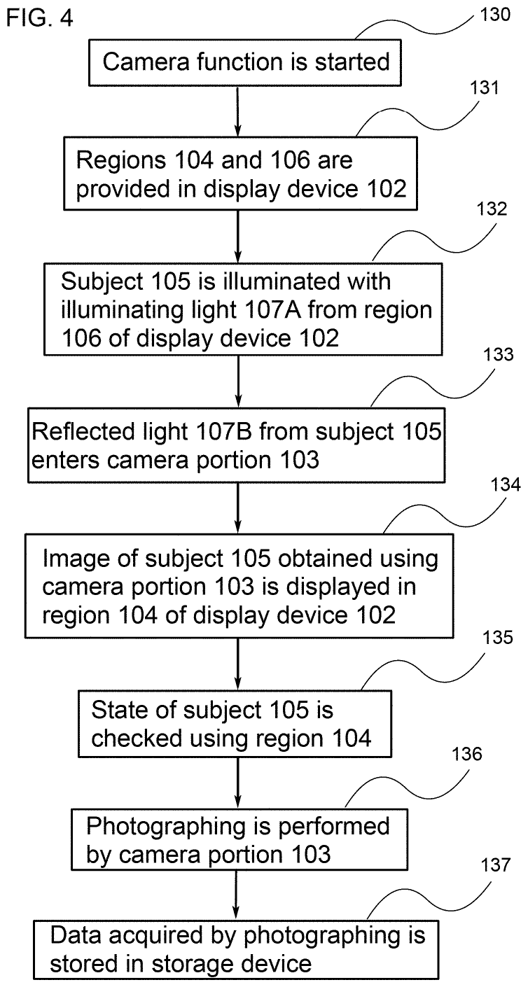

FIG. 4 is an example of a flow chart showing the case where a picture is taken using the camera portion 103, that is, the case where a picture is taken in the second mode.

In Step 130, a camera function is started first. To start the camera function, an icon 115A of software (application) for a camera that is displayed on the screen of the display device 102 as in FIG. 3 is double-clicked or touched, for example. Alternatively, a button or a switch provided for the electronic device 101 is pressed to start the camera function. As the software, software exclusive to a camera or a software that uses a camera for part of a function can be used. Examples of the case of using a camera as part of a function include a videophone and social networking service (SNS).

Then, in Step 131, the display device 102 includes the regions 104 and 106. At this time, another region may be provided in the display device 102. Alternatively, the region 104 or 106 may include a region where different display is performed; for example, at least one of a graph indicating the characteristics of an image, time, a charging state of a battery, a conduction state of radio waves, and the like is displayed.

In Step 132, the subject 105 is illuminated with the illuminating light 107A from 30 the region 106 of the display device 102. At this time, the intensity or the color of the illuminating light 107A may be changed. In that case, ambient light may illuminate the subject 105.

In Step 133, the reflected light 107B from the subject 105 enters the camera portion 103. It is needless to say that, light other than the reflected light 107B, for example, light from an object near the camera portion 103 also enters the camera portion 103. Then, photoelectric conversion is performed in the camera portion 103.

Note that Steps 132 and 133 may be performed at substantially the same time depending on the case.

In Step 134, an image of the subject 105 obtained using the camera portion 103 is displayed in the region 104 of the display device 102. This image is for a function of a viewfinder and used to check how a picture is taken. The display image is thus rewritten in real time. In other words, a moving image of the subject 105 obtained using the camera portion 103 is kept being displayed in the region 104 of the display device 102.

In Step 135, the state of the subject 105 is checked using the region 104. That is, an image displayed in the region 104 is checked to determine whether a picture may be taken. Note that the intensity or color of the illuminating light 107A may be changed depending on the state displayed in the region 104. For example, the intensity of the illuminating light 107A may be increased when the illuminance of the subject 105 is low. Furthermore, when the reproduction ratio is inappropriate, it may be changed such that a photographing area is within an appropriate range by enlarging or reducing an image with the use of a zoom function in the camera portion 103.

In Step 136, photographing is performed by the camera portion 103. In order to perform the photographing, a photographing execution button displayed on the screen of the display device 102, a button or a switch provided for the electronic device 101, or a photographing execution button provided for a device connected to the electronic device 101 by, for example, an electrical communication network may be pressed. Note that at this time, either a still image or an moving image can be taken, and a plurality of still images may be successively taken.

In Step 137, data acquired by the photographing is stored in a storage device. Note that the storage device may be provided in the electronic device 101 or connected to the electronic device 101 via, for example, an electrical communication network. The network for electrical communication or the like can be either a wired network or a wireless network. Examples of the storage device include volatile storage devices such as DRAM, nonvolatile storage devices such as flash memory, hard disks, DVDs, optical discs, and ROM, semiconductor memory, magnetic memory, magneto-optical disks, and organic memory.

After the photographing operation is completed in such a manner, the electronic device 101 returns to the first mode, i.e., a normal operation, and the data acquired by the photographing can be viewed or displayed using the display device 102.

Note that the order of these steps is only an example and may be partly reversed. Alternatively, some of the steps may be performed at the same time, or one step may be divided into some steps.

When the electronic device 101 is operated in such a manner, the display device can have both a displaying function and a lighting function. Note that it is preferred that both the functions be implemented while the camera portion 103 operates. Note that one embodiment of the present invention is not limited to this example. The display device 102 may also include the regions 104 and 106 when the camera portion 103 does not operate.

Here, the arrangement of the region 104 having a function as a viewfinder and the region 106 having a function as lighting will be considered. In FIG. 1A as an example, the region 104 is provided on the side near the camera portion 103. The region 106 is provided on the side apart from the camera portion 103. In the case where the region 104 is positioned on the side near the camera portion 103 and the subject 105 is a human, the line of sight of the subject 105 is easily directed to the camera portion 103. Specifically, the subject 105 checks the circumstance by viewing the region 104, whereby the line of his or her sight is easily directed to the position near the camera portion 103. The subject looking into the camera portion 103 is thus easily photographed when the line of his or her sight is maintained to be directed to the camera portion 103. As a result, a still or moving image of the subject looking into the camera portion is likely to be obtained.

Furthermore, the region 106 is away from the camera portion 103, so that illuminating light emitted from the region 106 is less likely to enter the camera portion 103 as noise. This can enhance the contrast of the taken image.

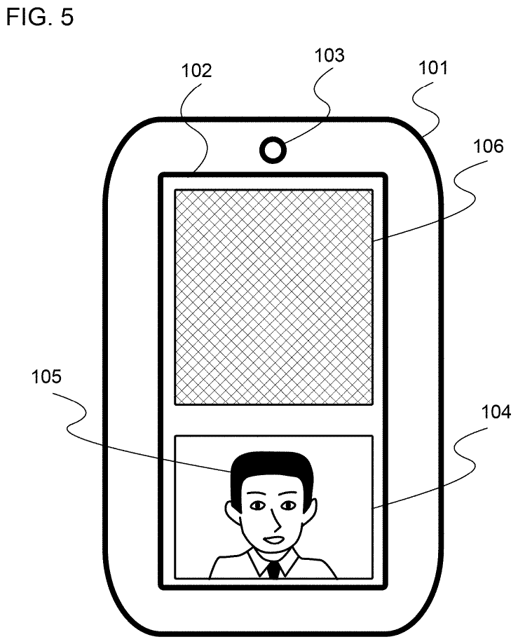

Note that one embodiment of the present invention is not limited to this example. For example, the region 106 may be provided on the side near the camera portion 103 as illustrated in FIG. 5, in which case the illuminating light 107A is easily delivered perpendicularly to the subject 105. Consequently, the subject 105 is less likely to be shaded and a clear image is easily taken.

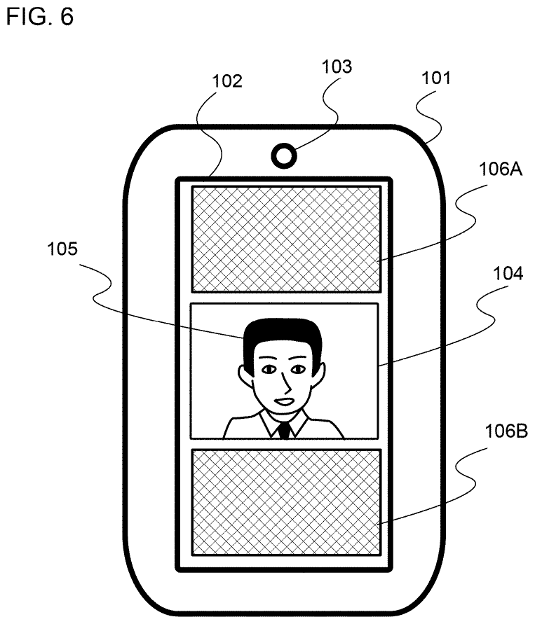

Although FIG. 1A and FIG. 5 illustrate the case where one region 104 and one region 106 are provided, one embodiment of the present invention is not limited to this example. A plurality of regions 104 and a plurality of regions 106 may be provided. For example, a lighting region may be divided into a region 106A and a region 106B as illustrated in FIG. 6. In that case, illuminating light can be delivered to the subject 105 from different regions, that is, different directions. This allows a clear image to be easily taken because the subject 105 is less likely to be shaded.

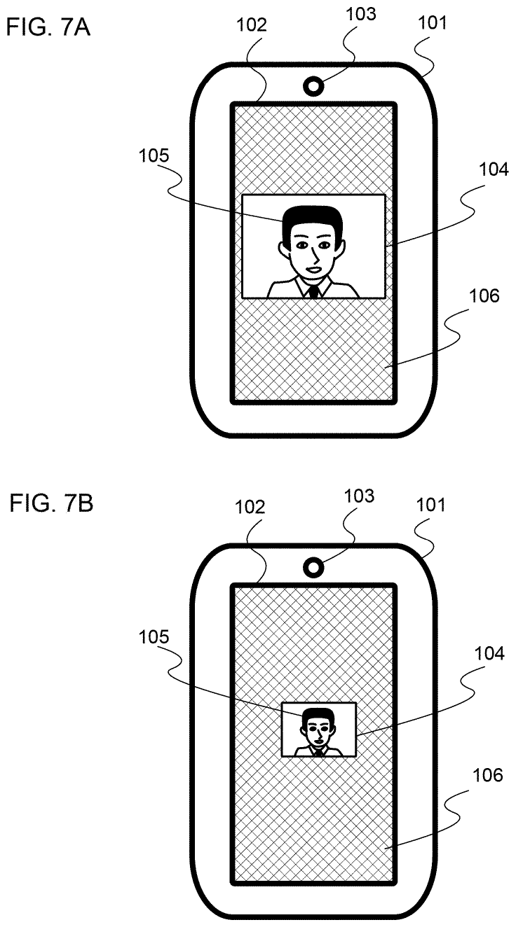

Although the regions 104 and 106 are arranged longitudinally in FIG. 1A, FIG. 5, and FIG. 6, one embodiment of the present invention is not limited to this example. The regions 104 and 106 may be arranged side by side, or the region 104 may be inside the region 106 as illustrated in FIG. 7A.

Note that at least one of the size, area, shape, position, color, brightness, and the like of the region 106 can be changed according to the circumstance. The intensity of light emitted from the region 106 can also be changed according to the circumstance. Similarly, at least one of the size, area, shape, position, color, brightness, and the like of the region 104 can be changed according to the circumstance. For example, FIG. 7B illustrates the case where the size of the region 104 in FIG. 7A is reduced. The region 104 can be changed by touching the screen with a finger or the like and drag the outer frame of the region 104.

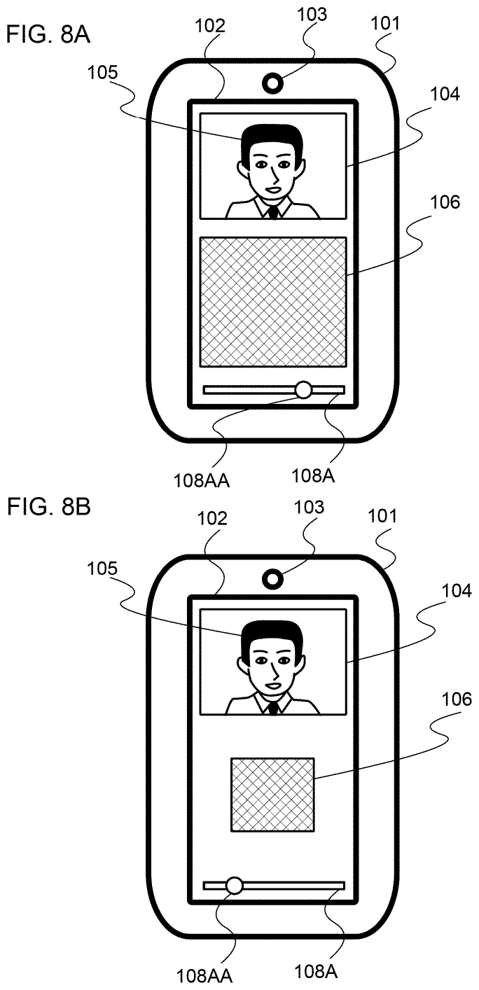

Alternatively, a dedicated user interface may be provided to control the screen. FIG. 8A illustrates the case where a slider 108A is positioned. A value can be changed by moving a button 108AA from side to side. FIG. 8B illustrates the case where the size of the region 106 is reduced. By moving the button 108AA of the slider 108A to left, the size of the region 106 is reduced.

Although the size of the region 106 is changed using the slider 108A in FIG. 8B, the size or magnitude of any other object may be changed. For example, the luminance of the region 106 may be changed using the slider 108A. Alternatively, an image of the region 106 may be changed.

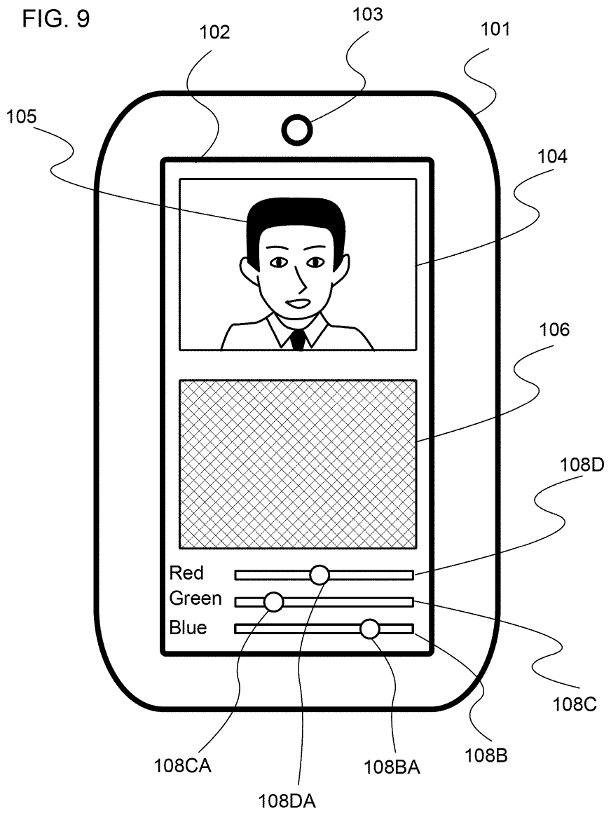

Alternatively, the color of the region 106 may be changed using a slider. FIG. 9 illustrates the case where the color of the region 106 is changed using a blue slider 108B, a green slider 108C, and a red slider 108D. The color of the region 106 can be changed by moving a blue button 108BA, a green button 108CA, and a red button 108DA from side to side.

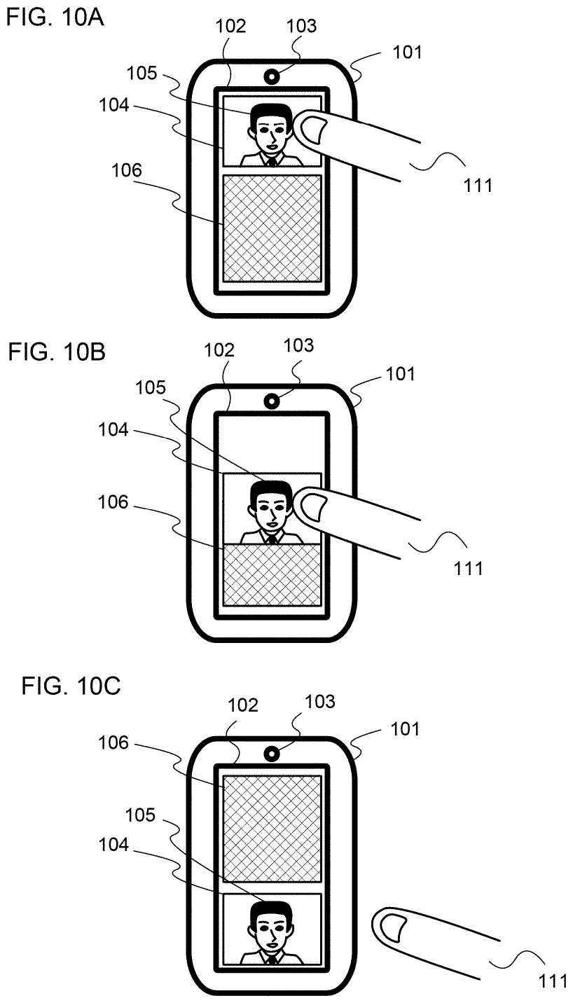

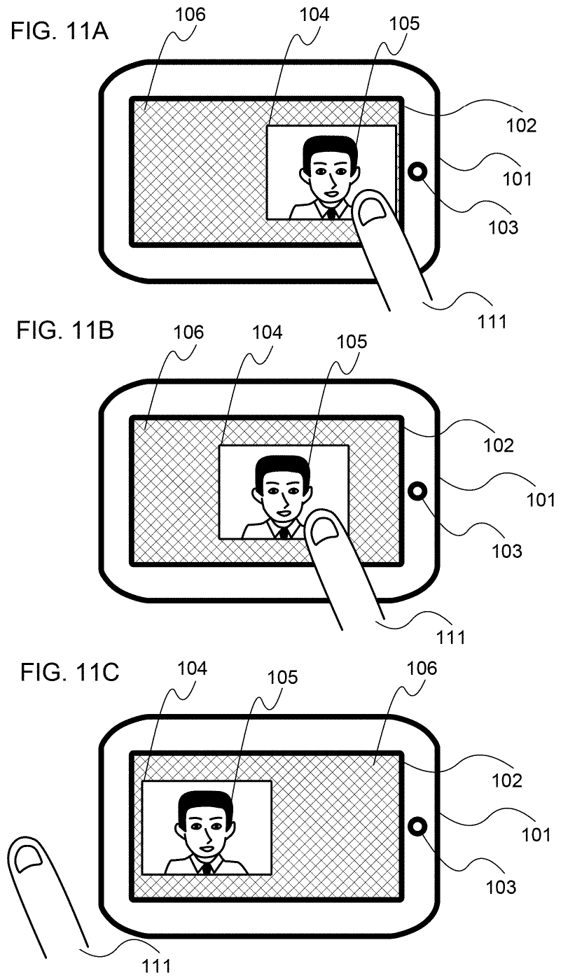

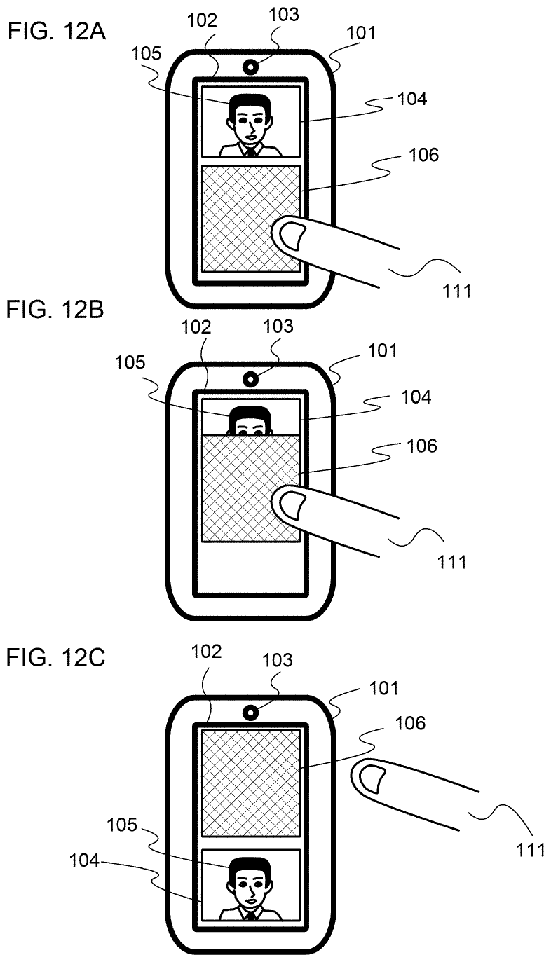

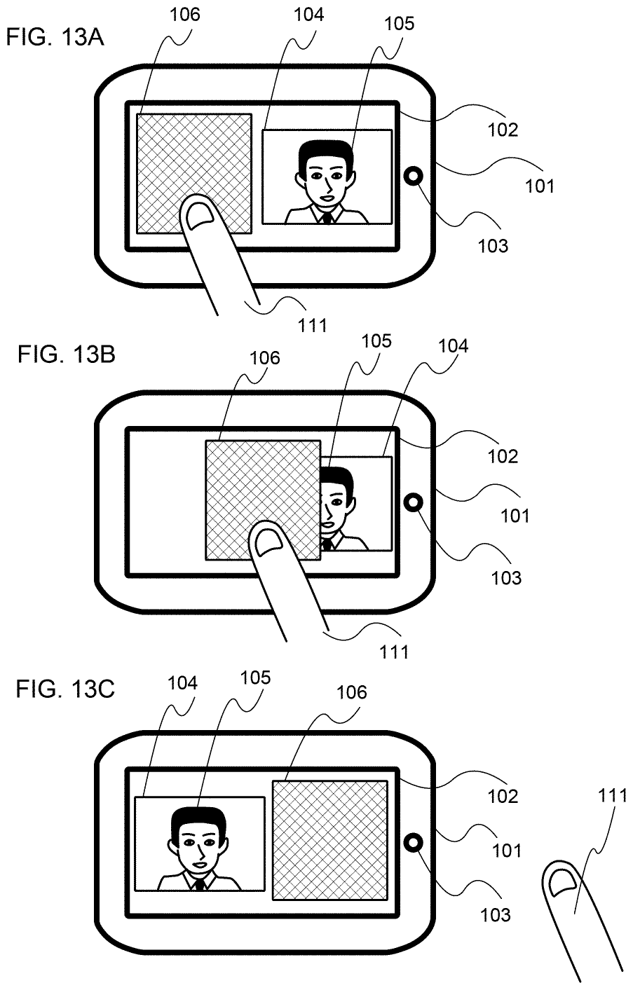

FIGS. 10A to 10C and FIGS. 11A to 11C illustrate the cases where the position of the region 104 is changed on the screen as examples. The region 104 is touched with a finger (or an object such as a pen) 111 as illustrated in FIG. 10A and FIG. 11A. Then, the region 104 is dragged to be moved leftward or downward as illustrated in FIG. 10B and FIG. 11B. After the region 104 is moved to the desired position, the finger (or object) 111 is released from the screen as illustrated in FIG. 10C and FIG. 11C. By such operations, the position of the region 104 on the screen can be changed. Note that the position of the region 106 can be changed in a similar manner. FIGS. 12A to 12C and FIGS. 13A to 13C illustrate such cases as examples.

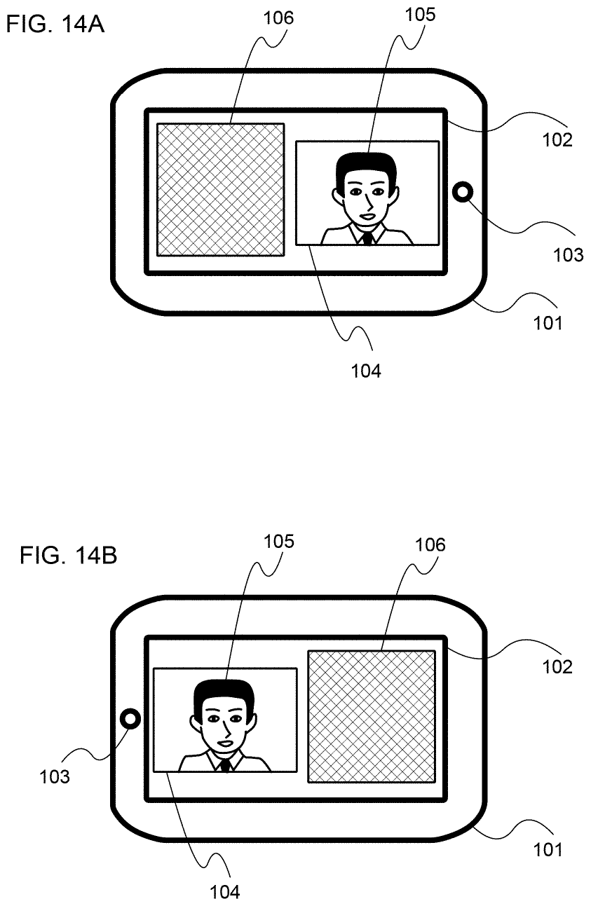

Note that when the electronic device 101 and the display device 102 are rotated, the arrangement of the regions 104 and 106 can be changed accordingly. For example, FIG. 14A illustrates the case where the electronic device 101 in FIG. 1A is rotated clockwise. In contrast, FIG. 14B illustrates the case where the electronic device 101 in FIG. 1A is rotated counterclockwise. The region 104 is positioned near the camera portion 103 in FIGS. 14A and 14B. This enables the line of sight of a subject to be easily directed to the camera portion 103. Note that one embodiment of the present invention is not limited to these examples.

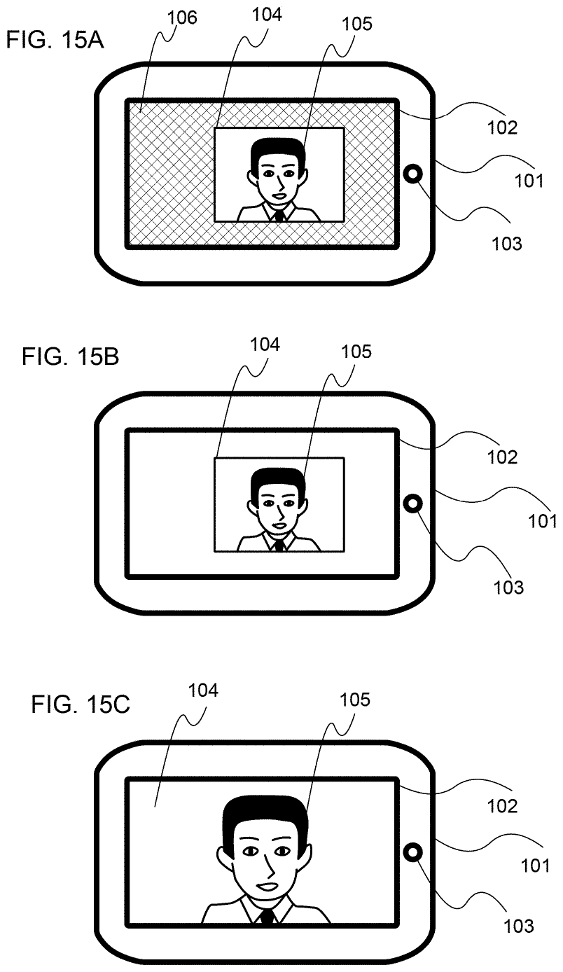

Note that in the case where ambient light is intense and bright in photographing with the use of the camera portion 103, the display device 102 is not necessarily used as lighting. For example, the region 106 may be provided as illustrated in FIG. 15A. Alternatively, it is possible that the region 106 not be provided as illustrated in FIG. 15B or the level of brightness of the region 106 be set to zero. Alternatively, the brightness of the region 106 may be set to equal to or substantially equal to that of the region 104, for example. That is to say, when photographing is performed using the camera portion 103, it is possible that the display device 102 not be used as lighting depending on the case or circumstance. In that case, the whole screen of the display device 102 may be used as the region 104 as illustrated in FIG. 15C.

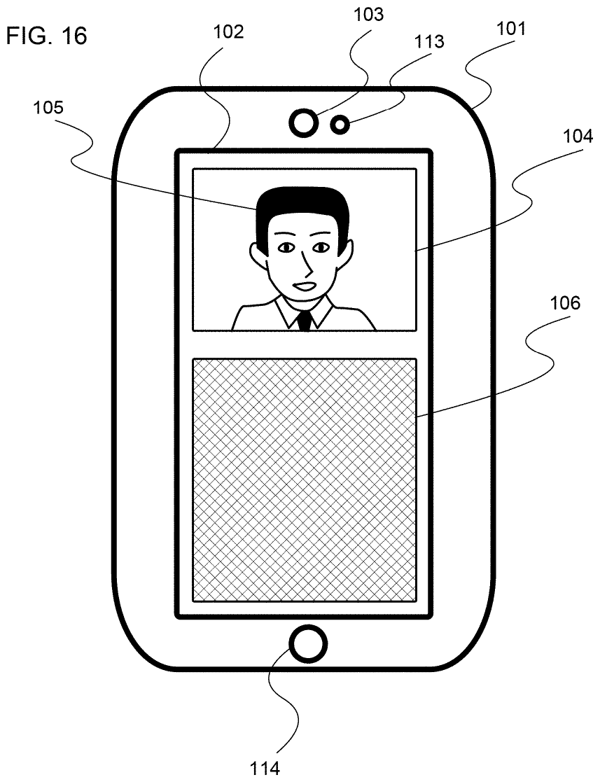

When the display device 102 is desired to be used as lighting, the brightness is insufficient in some cases. In such a case, a dedicated lighting component 113 may be provided besides the display device 102. FIG. 16 illustrates the case where the lighting component 113 is provided in the vicinity of the camera portion 103. Note that a plurality of lighting components 113 may be provided. The emission colors of the lighting components may be different. The lighting component 113 is formed using an LED, for example.

Note that when photographing is performed using the camera portion 103, at least one of various icons, various images, various characters, and the like can be displayed as well as the regions 104 and 106 on the screen of the display device 102. At least one of various icons, various images, various characters, and the like may be displayed inside or outside the region 104 or 106.

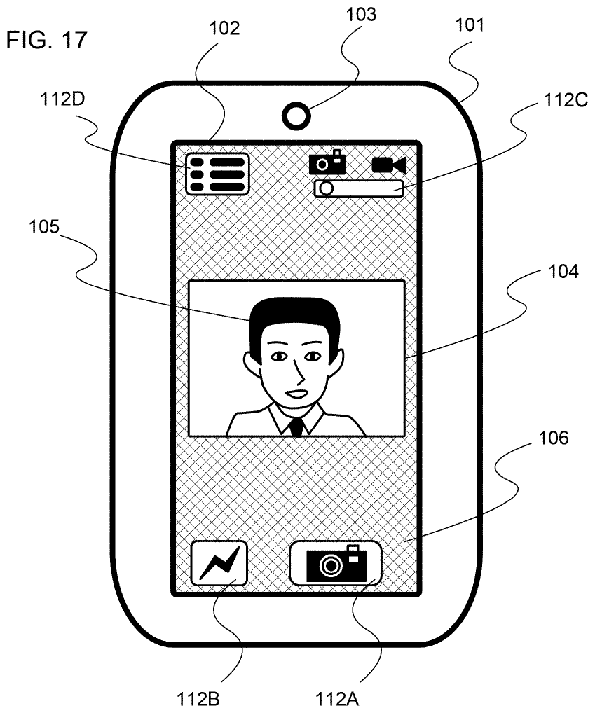

FIG. 17 illustrates the case where various icons and the like are arranged inside the region 106 as an example. An icon 112A is a photographing execution button and corresponds to a shutter button in a normal camera. A picture is taken by pressing this button. An icon 112B is a flash control button. With this icon, whether a flash is used can be determined. When the flash is automatically controlled, it can be used only in the case where the illuminance of the subject 105 is low. An icon 112C is a photographing mode button. With this icon, a still image or a moving image to be taken can be selected. An icon 112D is a property button. With this icon, whether a window for performing various settings is displayed can be determined.

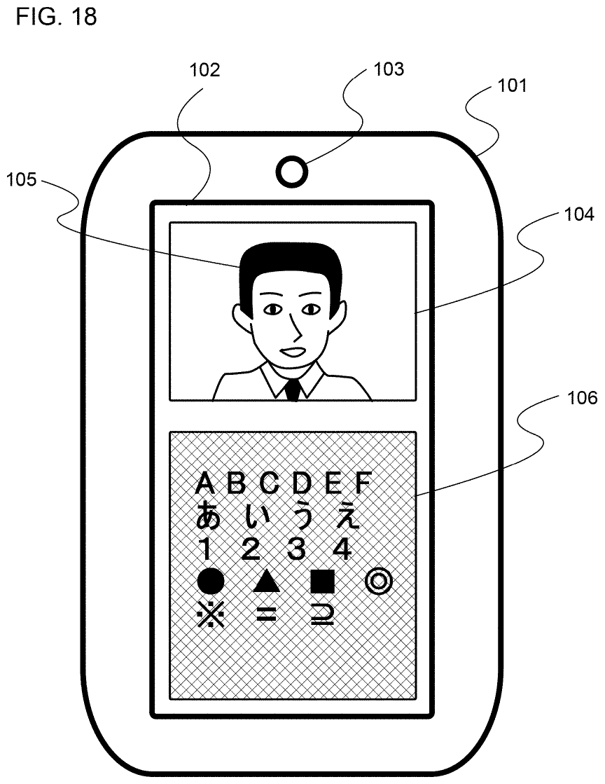

FIG. 18 illustrates the case where text is displayed inside the region 106 as another example.

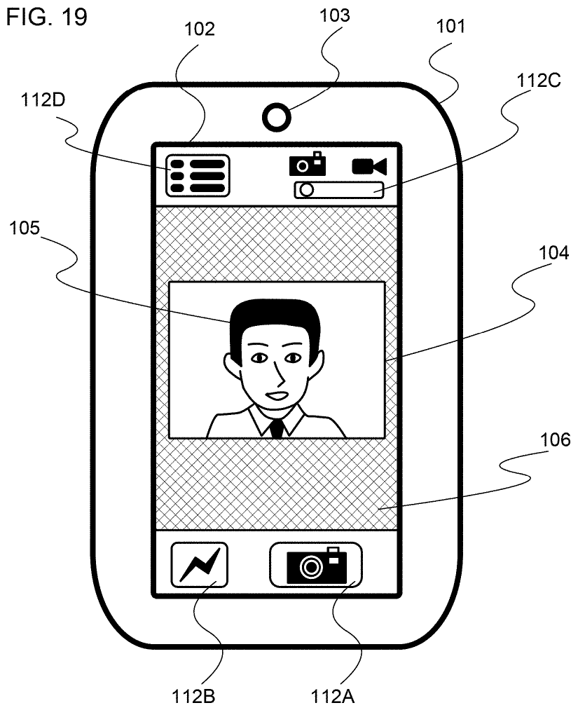

When various icons or the like are arranged inside the region 106, it may be able to be determined that the area where they are arranged does not emit intense illuminating light. In that case, burn-in or deterioration due to intense illuminating light does not occur in the area of the display device 102 in which the various icons or the like are arranged. In the case where various icons or the like are arranged in a normal mode, an area where the icons or the like are arranged may be set so as not to emit light in a lighting mode. Particularly in the case where the display device 102 is a self-light-emitting display device, burn-in or the like of the screen can be prevented. Note that in the case where a part of the region is not desired to emit light in the lighting mode, a lighting function can be implemented in such a manner that intense light is not emitted in a portion where an icon or the like is positioned and is emitted in an area other than the portion where an icon or the like is positioned as illustrated in FIG. 17. Alternatively, the lighting function can be implemented in the lighting mode in such a manner that intense light is not emitted in an area around the portion where an icon or the like is positioned and is emitted in an area except for the vicinity of the portion where an icon or the like is positioned as illustrated in FIG. 19.

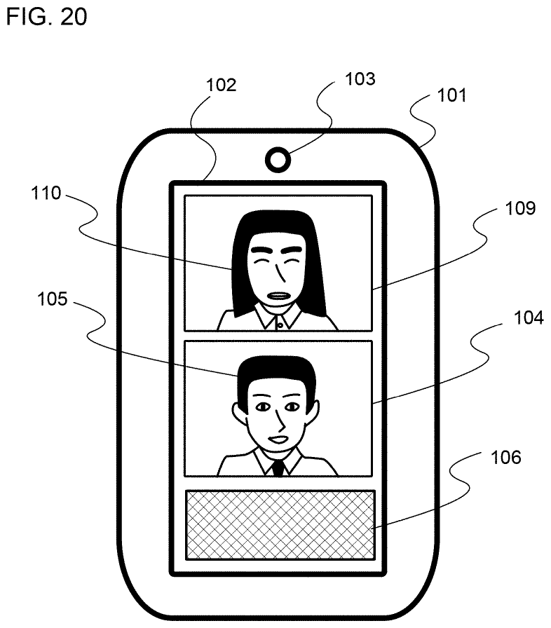

Another region may be provided outside the regions 104 and 106. FIG. 20 illustrates the case where a region 109 is provided, as an example. In FIG. 20, the case where a video-phone call is made is illustrated. An image of an intended party 110 is displayed in the region 109. The region 109 is positioned in the vicinity of the camera portion 103. This allows an image of a user looking into the camera portion 103 can be taken when he or she talks while viewing an image of the intended party 110.

Note that various switches or buttons can be provided for the electronic device 101. For example, FIG. 16 illustrates the case where a button 114 for going back to a home screen is provided.

In this embodiment, an example of a basic principle is described. Thus, part or the whole of this embodiment can be freely combined with, applied to, or replaced with part or the whole of another embodiment.

### Embodiment 2

In this embodiment, a structure of an electronic device of one embodiment of the present invention will be described.

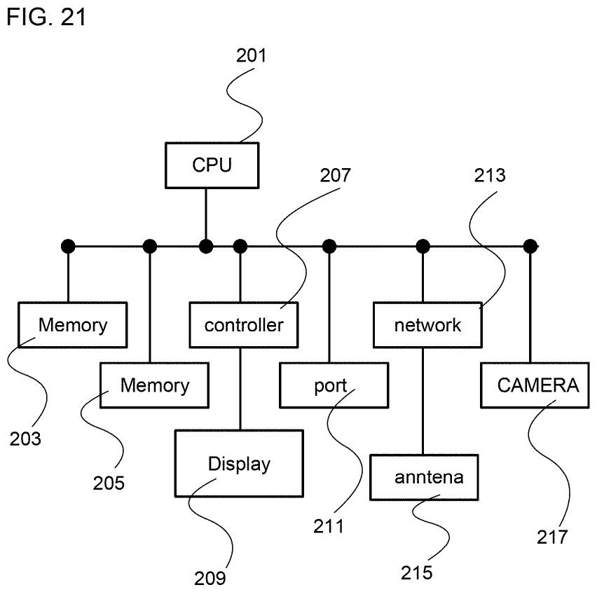

First, FIG. 21 shows a rough structural diagram of the inside of the electronic device 101.

A CPU 201 can conduct a variety of calculations and processings and controls a variety of portions.

The storage device 203 stores at least one of various data, programs, and application software. For example, the storage device 203 can deal with nonvolatile storage media such as flash memory, magnetic disks, CDROM, DVD, and magneto-optical disks. Application software (program) having such a function as is described in Embodiment 1 may be stored in the storage device 203 or a storage medium used therein.

The storage device 205 stores at least one of various data, programs, and application software. For example, the storage device 203 is a volatile storage device such as DRAM. The CPU 201 can conduct a variety of processings with the use of data or a program stored in the storage device 205. Application software (program) having such a function as is described in Embodiment 1 may be stored in the storage device 203.

The controller 207 can control the display device 209. The display device 102 illustrated in FIGS. 1A and 1B and the like corresponds to a part or the whole of the display device 209 or the whole of both the display device 209 and the controller 207. The display device 209 can display an image or a user interface used for application software (program) having such a function as is described in Embodiment 1.

An external port 211 can communicate data with the outside. For example, a detachable storage medium is connected to the external port 211, whereby at least one of various data and software (programs) can be stored in the detachable storage medium. Alternatively, a detachable storage device is connected to the external port 211, whereby at least one of various data and software (programs) can be stored in the detachable storage medium or a storage medium controlled therein. For example, the external port 211 can be connected to a storage device including a semiconductor memory, a magnetic memory, or the like, or a storage medium such as a CD or a DVD. Note that an object that is connected to the external port 211 is detachable and thus is not always connected thereto. Application software (program) having such a function as is described in Embodiment 1 may thus be stored in an object that can be connected to the external port 211, for example, a detachable storage medium.

A network control portion 213 can control a network such as the Internet. For example, a wired cable is connected to the network control portion 213 to establish a LAN. Alternatively, an antenna 215 is connected to the network control portion 213 to build a wireless network. This allows data communication. For example, when the electronic device 101 is connected to an external device through the network control portion 213, at least one of various data and software (programs) can be stored or downloaded into the electronic device 101. Application software (program) having such a function as is described in Embodiment 1 may thus be downloaded through the network. Alternatively, application software (program) having such a function as is described in Embodiment 1 may be executed by a connected device through the network, and the display device 102 of the electronic device may display the result.

A camera portion 217 can photograph a still image and a moving image. Furthermore, the camera portion 217 can take a zoom-in image or a zoom-out image by adjusting a lens or the like. The camera portion 217 corresponds to a part or the whole of the camera portion 103 illustrated in FIGS. 1A and 1B.

Various components are controlled in such a manner to operate the electronic device 101. Application software (program) having such a function as is described in Embodiment 1 also controls the operations of the components of the electronic device 101.

Next, FIG. 3 illustrates an example of the screen of the display device 102 when the electronic device 101 is booted. Various icons are displayed on the screen. Respective icons correspond to respective application software programs having various functions. For example, an icon 115A is software for a camera, and a program for a camera can be executed with this icon. This software (program) can implement such a function as is described in Embodiment 1. The software (program) can thus control at least one of the camera portion 103, the display device 102, the camera portion 217, the display device 209, and the like.

An icon 115B is software for a telephone, and a program for a telephone can be executed with this icon. For example, a video-phone call can be made. This software can implement such a function as is described in Embodiment 1. The software (program) can thus control at least one of the camera portion 103, the display device 102, the camera portion 217, the display device 209, the network control portion 213, and the like.

Besides these icons, various other ions are displayed. In each application such as SNS, e-mail, or a WEB service, a function as is described in Embodiment 1 can be used.

Such software (program) is stored in the storage device 203, the storage device 205, or the like, a storage medium therein, or a detachable storage medium or storage device that can communicate data through the external port 211. Examples of the detachable storage device include a memory card and a USB memory.

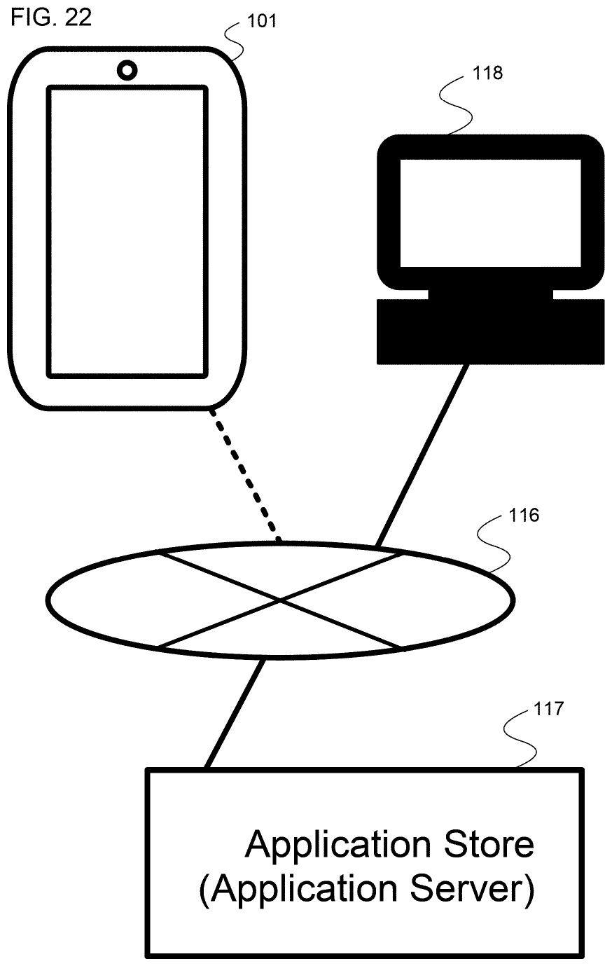

Furthermore, such software (program) can be downloaded into the electronic device 101 through the network control portion 213 or the like. FIG. 22 is a schematic view illustrating the case. The electronic device 101 is connected to a network 116 with or without wires. A server 117 that can provide software is connected to the network 116. When the electronic device 101 accesses the server 117, desired software (program) can be acquired, downloaded, purchased, or rent. Note that not the electronic device 101 but another computer 118 may be connected to the network 116. When the computer 118 accesses the server 117, desired software (program) can be acquired, downloaded, purchased, or rent. In addition, the software (program) can be transferred from the computer 118 to the electronic device 101 through a portable storage medium, for example.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 3

In this embodiment, another structure of an electronic device of one embodiment of the present invention will be described.

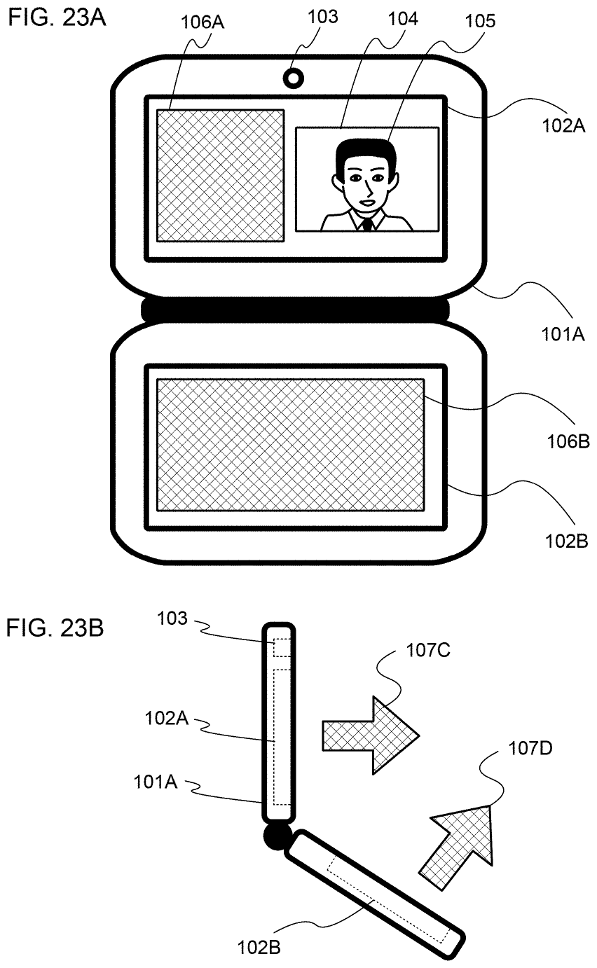

As illustrated in FIG. 23A, an electronic device 101A includes, for example, a display device 102A and a display device 102B. The region 106 is divided into two regions of a region 106A and a region 106B, for example, and the display device 102A and the display device 102B are provided with the region 106A and the region 106B, respectively.

Although in FIG. 23A, the display device 102A and the display device 102B are provided with the region 106A and the region 106B, respectively, one embodiment of the present invention is not limited to this example. For example, only one of the display device 102A and the display device 102B may be provided with the region 106.

FIG. 23B is a side view. The electronic device 101A can be folded in half, for example. There are illuminating light 107C emitted from the region 106A of the display device 102A and illuminating light 107D emitted from the region 106B of the display device 102B. When the electronic device 101A is folded in half, the illuminating light 107C and the illuminating light 107D are delivered in different directions. This allows a clear image to be easily taken because the subject 105 is less likely to be shaded.

In this embodiment, an example of a basic principle is described. Thus, part or the whole of this embodiment can be freely combined with, applied to, or replaced with part or the whole of another embodiment.

### Embodiment 4

In this embodiment, a structural example of a display device of one embodiment of the present invention will be described.

### [Structural Example]

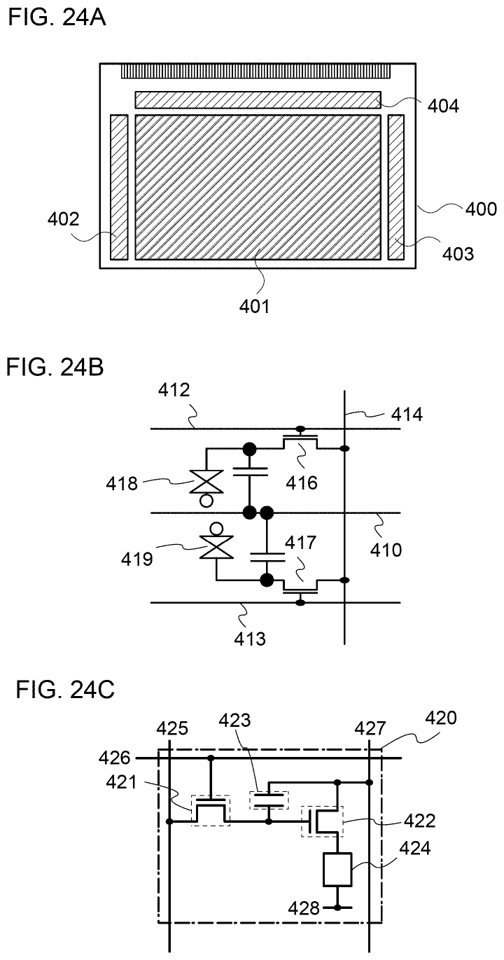

FIG. 24A is a top view of the display device of one embodiment of the present invention. FIG. 24B is a circuit diagram illustrating a pixel circuit that can be used in the case where a liquid crystal element is used in a pixel in the display device of one embodiment of the present invention. FIG. 24C is a circuit diagram illustrating a pixel circuit that can be used in the case where an organic EL element is used in a pixel in the display device of one embodiment of the present invention.

A transistor in the pixel portion can be formed according to any of various methods such as methods described in other embodiments. The transistor can easily be an n-channel transistor, and thus, part of a driver circuit that can be formed using an n-channel transistor in the driver circuit is formed over the same substrate as the transistor of the pixel portion. The use of the transistor described in any of the other embodiments for the pixel portion or the driver circuit in this manner allows fabrication of a highly reliable display device.

FIG. 24A illustrates an example of a top view of an active matrix display device. A pixel portion 401, a first scan line driver circuit 402, a second scan line driver circuit 403, and a signal line driver circuit 404 are provided over a substrate 400 of the display device. In the pixel portion 401, a plurality of signal lines extended from the signal line driver circuit 404 is arranged and a plurality of scan lines extended from the first scan line driver circuit 402 and the second scan line driver circuit 403 is arranged. Note that pixels each including a display element are provided in matrix in respective regions in each of which the scan line and the signal line intersect with each other. Furthermore, the substrate 400 in the display device is connected to a timing control circuit (also referred to as a controller or a controller IC) through a connection portion such as a flexible printed circuit (FPC).

In FIG. 24A, the first scan line driver circuit 402, the second scan line driver circuit 403, and the signal line driver circuit 404 are provided over the same substrate 400 as the pixel portion 401. Accordingly, the number of components which are provided outside, such as a driver circuit, are reduced, so that a reduction in cost can be achieved. Furthermore, if the driver circuit is provided outside the substrate 400, wirings would need to be extended and the number of connections of wirings would be increased. However, by providing the driver circuit over the substrate 400, the number of connections of the wirings can be reduced, leading to improved reliability or yield.

### [Liquid Crystal Display Device]

FIG. 24B illustrates an example of a circuit configuration of the pixel. Here, a pixel circuit that can be used in a pixel of a VA liquid crystal display device is illustrated.

This pixel circuit can be used in a structure where one pixel includes a plurality of pixel electrode layers. The pixel electrode layers are connected to different transistors, and the transistors can be driven with different gate signals. Accordingly, signals supplied to individual pixel electrode layers in a multi-domain pixel can be controlled independently.

A gate wiring 412 of a transistor 416 and a gate wiring 413 of a transistor 417 are separated from each other so that different gate signals can be supplied thereto. In contrast, a source or drain electrode layer 414 functioning as a data line is shared by the transistors 416 and 417. The transistor described in any of the other embodiments can be used as appropriate as each of the transistors 416 and 417. Thus, a highly reliable liquid crystal display device can be provided.

The shapes of a first pixel electrode layer electrically connected to the transistor 416 and a second pixel electrode layer electrically connected to the transistor 417 will be described. The first pixel electrode layer and the second pixel electrode layer are separated by a slit. The first pixel electrode layer has a V shape and the second pixel electrode layer is provided so as to surround the first pixel electrode layer.

A gate electrode of the transistor 416 is connected to the gate wiring 412, and a gate electrode of the transistor 417 is connected to the gate wiring 413. Different gate signals are supplied to the gate wiring 412 and the gate wiring 413, whereby operation timings of the transistor 416 and the transistor 417 can be varied. As a result, alignment of liquid crystals can be controlled.

A storage capacitor may be formed using a capacitor wiring 410, a gate insulating film functioning as a dielectric, and a capacitor electrode electrically connected to the first pixel electrode layer or the second pixel electrode layer.

The multi-domain pixel includes a first liquid crystal element 418 and a second liquid crystal element 419. The first liquid crystal element 418 includes the first pixel electrode layer, a counter electrode layer, and a liquid crystal layer therebetween. The second liquid crystal element 419 includes the second pixel electrode layer, a counter electrode layer, and a liquid crystal layer therebetween.

Note that a pixel circuit of one embodiment of the present invention is not limited to that shown in FIG. 24B. For example, a switch, a resistor, a capacitor, a transistor, a sensor, or a logic circuit may be added to the pixel illustrated in FIG. 24B.

### [Organic EL Display Device]

FIG. 24C illustrates another example of a circuit configuration of the pixel. Here, a pixel structure of a display device using an organic EL element is illustrated.

In an organic EL element, by application of voltage to a light-emitting element, electrons are injected from one of a pair of electrodes and holes are injected from the other of the pair of electrodes, into a layer containing a light-emitting organic compound; thus, current flows. The electrons and holes are recombined, and thus, the light-emitting organic compound is excited. The light-emitting organic compound returns to a ground state from the excited state, thereby emitting light. Based on such a mechanism, such a light-emitting element is referred to as a current-excitation type light-emitting element.

FIG. 24C illustrates an example of a pixel circuit that can be used. In this example, one pixel includes two n-channel transistors. Note that a metal oxide film of one embodiment of the present invention can be used for channel formation regions of the n-channel transistors. Digital time grayscale driving can be employed for the pixel circuit.

The configuration of the pixel circuit that can be used and operations of a pixel using digital time grayscale driving will be described.

A pixel 420 includes a switching transistor 421, a driver transistor 422, a light-emitting element 424, and a capacitor 423. A gate electrode layer of the switching transistor 421 is connected to a scan line 426, a first electrode (one of a source electrode layer and a drain electrode layer) of the switching transistor 421 is connected to a signal line 425, and a second electrode (the other of the source electrode layer and the drain electrode layer) of the switching transistor 421 is connected to a gate electrode layer of the driver transistor 422. The gate electrode layer of the driver transistor 422 is connected to a power supply line 427 through the capacitor 423, a first electrode of the driver transistor 422 is connected to the power supply line 427, and a second electrode of the driver transistor 422 is connected to a first electrode (pixel electrode) of the light-emitting element 424. A second electrode of the light-emitting element 424 corresponds to a common electrode 428. The common electrode 428 is electrically connected to a common potential line formed over the same substrate as the common electrode 428.

As the switching transistor 421 and the driver transistor 422, any of the transistors described in the other embodiments can be used as appropriate. Thus, a highly reliable organic EL display device can be provided.

The potential of the second electrode (the common electrode 428) of the light-emitting element 424 is set to be a low power supply potential. Note that the low power supply potential is a potential satisfying the relation, the low power supply potential<a high power supply potential, which is supplied to the power supply line 427. The high power supply potential and the low power supply potential are set to be higher than or equal to the forward threshold voltage of the light-emitting element 424, and the difference between the potentials is applied to the light-emitting element 424, whereby current is supplied to the light-emitting element 424, leading to light emission. The forward voltage of the light-emitting element 424 refers to voltage at which a desired luminance is obtained, and at least includes forward threshold voltage.

Note that gate capacitance of the driver transistor 422 may be used as a substitute for the capacitor 423, so that the capacitor 423 can be omitted. The gate capacitance of the driver transistor 422 may be formed between a channel formation region and the gate electrode layer.

Next, a signal input to the driver transistor 422 will be described. In the case of a voltage-input voltage driving method, a video signal for sufficiently turning on or off the driver transistor 422 is input to the driver transistor 422. In order for the driver transistor 422 to operate in a linear region, voltage higher than the voltage of the power supply line 427 is applied to the gate electrode layer of the driver transistor 422. Note that voltage greater than or equal to voltage which is the sum of power supply line voltage and the threshold voltage Vth of the driver transistor 422 is applied to the signal line 425.

In the case of performing analog grayscale driving, voltage greater than or equal to voltage which is the sum of the forward voltage of the light-emitting element 424 and the threshold voltage Vth of the driver transistor 422 is applied to the gate electrode layer of the driver transistor 422. A video signal by which the driver transistor 422 is operated in a saturation region is input, so that current is supplied to the light-emitting element 424. In order for the driver transistor 422 to operate in a saturation region, the potential of the power supply line 427 is set higher than the gate potential of the driver transistor 422. When an analog video signal is used, it is possible to feed current to the light-emitting element 424 in accordance with the video signal and perform analog grayscale driving.

Note that the configuration of the pixel circuit is not limited to that shown in FIG. 24C. For example, a switch, a resistor, a capacitor, a sensor, a transistor, a logic circuit, or the like may be added to the pixel circuit illustrated in FIG. 24C.

In the case where the transistor illustrated in any of the other embodiments is used for any of the circuits illustrated in FIGS. 24A to 24C, the source electrode (the first electrode) is electrically connected to the low potential side and the drain electrode (the second electrode) is electrically connected to the high potential side. Furthermore, the potential of a first gate electrode may be controlled by a control circuit or the like, and the potential described above as an example, e.g., a potential lower than the potential supplied to the source electrode, may be input to a second gate electrode through a wiring that is not illustrated.

For example, in this specification and the like, a display element, a display device that is a device including a display element, a light-emitting element, and a light-emitting device that is a device including a light-emitting element can employ a variety of modes or can include a variety of elements.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 5

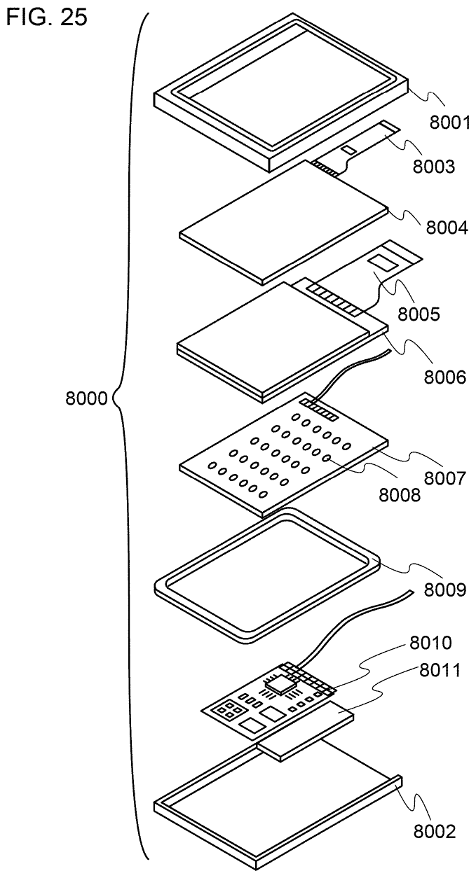

In this embodiment, a display module using a semiconductor device of one embodiment of the present invention will be described with reference to FIG. 25.

In a display module 8000 illustrated in FIG. 25, a touch panel 8004 connected to an FPC 8003, a display panel 8006 connected to an FPC 8005, a backlight unit 8007, a frame 8009, a printed board 8010, and a battery 8011 are provided between an upper cover 8001 and a lower cover 8002. Note that the backlight unit 8007, the battery 8011, the touch panel 8004, and the like are not provided in some cases.

The semiconductor device of one embodiment of the present invention can be used for, for example, the display panel 8006.

The shapes and sizes of the upper cover 8001 and the lower cover 8002 can be changed as appropriate in accordance with the sizes of the touch panel 8004 and the display panel 8006.

The touch panel 8004 can be a resistive touch panel or a capacitive touch panel and may be formed so as to overlap with the display panel 8006. A counter substrate (sealing substrate) of the display panel 8006 can have a touch panel function. A photosensor may be provided in each pixel of the display panel 8006 to form an optical touch panel. An electrode for a touch sensor may be provided in each pixel of the display panel 8006 so that a capacitive touch panel is obtained.

The backlight unit 8007 includes a light source 8008. The light source 8008 may be provided at an end portion of the backlight unit 8007 and a light diffusing plate may be used.

The frame 8009 protects the display panel 8006 and functions as an electromagnetic shield for blocking electromagnetic waves generated by the operation of the printed board 8010. The frame 8009 may function as a radiator plate.

The printed board 8010 is provided with a power supply circuit and a signal processing circuit for outputting a video signal and a clock signal. As a power source for supplying power to the power supply circuit, an external commercial power source or a power source using the battery 8011 provided separately may be used. The battery 8011 can be omitted in the case of using a commercial power source.

The display module 8000 may be additionally provided with a member such as a polarizing plate, a retardation plate, or a prism sheet.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 6

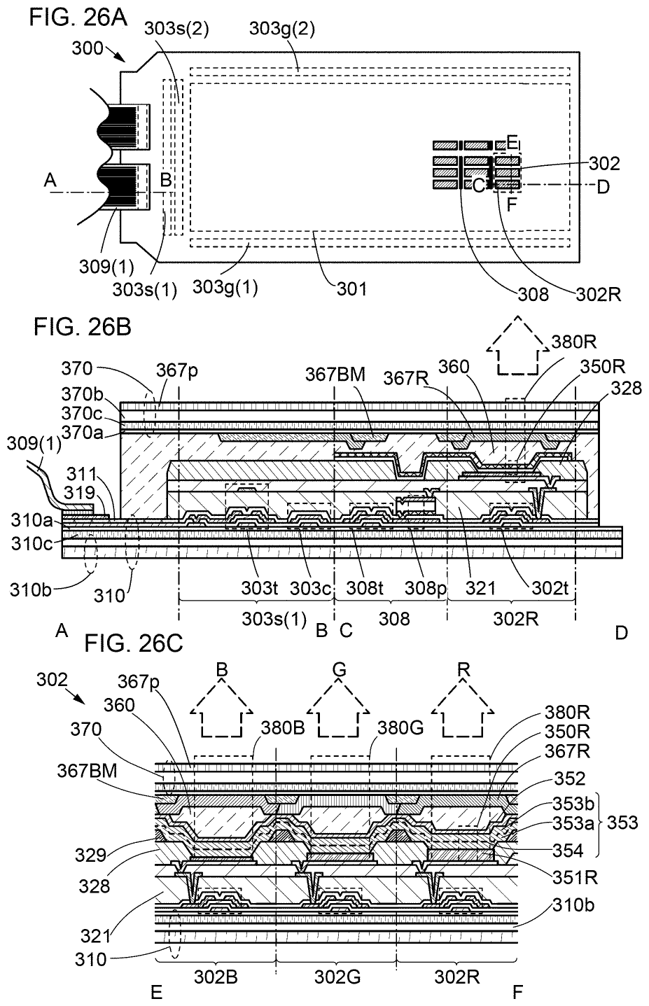

In this embodiment, a structure of a touch panel that can be used in an electronic device of one embodiment of the present invention will be described with reference to FIGS. 26A to 26C. Note that the touch panel may be foldable.

FIG. 26A is a front view illustrating a structure of a touch panel that can be used in an electronic device of one embodiment of the present invention.

FIG. 26B is a cross-sectional view along A-B and C-D in FIG. 26A.

FIG. 26C is a cross-sectional view along E-F in FIG. 26A.

### <Top View>

A touch panel 300 described as an example in this embodiment includes a display portion 301 (see FIG. 26A).

The display portion 301 includes a plurality of pixels 302 and a plurality of imaging pixels 308. The imaging pixels 308 can sense a touch of a finger or the like on the display portion 301. A touch sensor can thus be formed using the imaging pixels 308.

Each of the pixels 302 includes a plurality of sub-pixels (e.g., a sub-pixel 302R). In addition, the sub-pixels are provided with light-emitting elements and pixel circuits that can supply electric power for driving the light-emitting elements.

The pixel circuits are electrically connected to wirings through which selection signals are supplied and wirings through which image signals are supplied.

Furthermore, the touch panel 300 is provided with a scan line driver circuit 303g(1) that can supply selection signals to the pixels 302 and an image signal line driver circuit 303s(1) that can supply image signals to the pixels 302.

The imaging pixels 308 include photoelectric conversion elements and imaging pixel circuits that drive the photoelectric conversion elements.

The imaging pixel circuits are electrically connected to wirings through which control signals are supplied and wirings through which power supply potentials are supplied.

Examples of the control signals include a signal for selecting an imaging pixel circuit from which a recorded imaging signal is read, a signal for initializing an imaging pixel circuit, and a signal for determining the time taken for an imaging pixel circuit to sense light.

The touch panel 300 is provided with an imaging pixel driver circuit 303g(2) that can supply control signals to the imaging pixels 308 and an imaging signal line driver circuit 303s(2) that reads imaging signals.

### <Cross-Sectional View>

The touch panel 300 includes a substrate 310 and a counter substrate 370 that faces the substrate 310 (see FIG. 26B).

The substrate 310 is a stack in which a flexible substrate 310b, a barrier film 310a that prevents diffusion of impurities to the light-emitting elements, and an adhesive layer 310c that bonds the barrier film 310a to the substrate 310b are stacked.

The counter substrate 370 is a stack including a flexible substrate 370b, a barrier film 370a that prevents diffusion of impurities to the light-emitting elements, and an adhesive layer 370c that attaches the barrier film 370a to the substrate 370b (see FIG. 26B).

A sealant 360 bonds the counter substrate 370 to the substrate 310. The sealant 360 also serving as an optical adhesive layer has a refractive index higher than that of air. The pixel circuits and the light-emitting elements (e.g., a first light-emitting element 350R) are provided between the substrate 310 and the counter substrate 370.

### <<Pixel Structure>>

Each of the pixels 302 includes a sub-pixel 302R, a sub-pixel 302G, and a sub-pixel 302B (see FIG. 26C). The sub-pixel 302R includes a light-emitting module 380R, the sub-pixel 302G includes a light-emitting module 380G, and the sub-pixel 302B includes a light-emitting module 380B.

For example, the sub-pixel 302R includes the first light-emitting element 350R and a pixel circuit that can supply electric power to the first light-emitting element 350R and includes a transistor 302t (see FIG. 26B). The light-emitting module 380R includes the first light-emitting element 350R and an optical element (e.g., a first coloring layer 367R).

The first light-emitting element 350R includes a lower electrode 351R, an upper electrode 352, and a layer 353 containing a light-emitting organic compound between the lower electrode 351R and the upper electrode 352 (see FIG. 26C).

The layer 353 containing a light-emitting organic compound includes a light-emitting unit 353a, a light-emitting unit 353b, and an intermediate layer 354 between the light-emitting units 353a and 353b.

The light-emitting module 380R includes the first coloring layer 367R on the counter substrate 370. The coloring layer transmits light with a particular wavelength and is, for example, a layer that selectively transmits red, green, or blue light. Alternatively, a region that transmits light emitted from the light-emitting element as it is may be provided.

The light-emitting module 380R, for example, includes the sealant 360 that is in contact with the first light-emitting element 350R and the first coloring layer 367R.

The first coloring layer 367R is positioned in a region overlapping with the first light-emitting element 350R. Accordingly, part of light emitted from the first light-emitting element 350R passes through the sealant 360 that also serves as an optical adhesive layer and through the first coloring layer 367R and is emitted to the outside of the light-emitting module 380R as indicated by arrows in FIGS. 26B and 26C.

Note that although the case where the light-emitting element is used as a display element is described here, one embodiment of the present invention is not limited thereto.

For example, in this specification and the like, a display element, a display device, which is a device including a display element, a light-emitting element, and a light-emitting device, which is a device including a light-emitting element, can employ a variety of modes or can include a variety of elements. Examples of a display element, a display device, a light-emitting element, or a light-emitting device include a display medium whose contrast, luminance, reflectance, transmittance, or the like is changed by an electromagnetic action, such as an electroluminescence (EL) element (e.g., an EL element including organic and inorganic materials, an organic EL element, and an inorganic EL element), an LED (e.g., a white LED, a red LED, a green LED, and a blue LED), a transistor (a transistor that emits light depending on current), an electron emitter, a liquid crystal element, electronic ink, an electrophoretic element, a grating light valve (GLV), a plasma display panel (PDP), a display element using micro electro mechanical system (MEMS), a digital micromirror device (DMD), a digital micro shutter (DMS), MIRASOL (registered trademark), an interferometric modulation (IMOD) element, a MEMS shutter display element, an optical-interference-type MEMS display element, an electrowetting element, a piezoelectric ceramic display, and a carbon nanotube. Note that examples of display devices using EL elements include an EL display. Examples of display devices including electron emitters include a field emission display (FED) and an SED-type flat panel display (SED: surface-conduction electron-emitter display). Examples of display devices using liquid crystal elements include a liquid crystal display (e.g., a transmissive liquid crystal display, a transflective liquid crystal display, a reflective liquid crystal display, a direct-view liquid crystal display, and a projection liquid crystal display). An example of a display device including electronic ink or electrophoretic elements is electronic paper. In the case of a transflective liquid crystal display or a reflective liquid crystal display, some or all of pixel electrodes function as reflective electrodes. For example, some or all of pixel electrodes are formed to contain aluminum, silver, or the like. In such a case, a memory circuit such as an SRAM can be provided under the reflective electrodes, leading to lower power consumption.

### <<Touch Panel Structure>>

The touch panel 300 includes a light-blocking layer 367BM on the counter substrate 370. The light-blocking layer 367BM is provided so as to surround the coloring layer (e.g., the first coloring layer 367R).

The touch panel 300 includes an anti-reflective layer 367p positioned in a region overlapping with the display portion 301. As the anti-reflective layer 367p, a circular polarizing plate can be used, for example.

The touch panel 300 includes an insulating film 321. The insulating film 321 covers the transistor 302t. Note that the insulating film 321 can be used as a layer for planarizing unevenness caused by the pixel circuits. An insulating film on which a layer that can prevent diffusion of impurities to the transistor 302t and the like is stacked can be used as the insulating film 321.

The touch panel 300 includes the light-emitting element (e.g., the first light-emitting element 350R) over the insulating film 321.

The touch panel 300 includes, over the insulating film 321, a partition 328 that overlaps with an end portion of the lower electrode 351R (see FIG. 26C). In addition, a spacer 329 that controls the distance between the substrate 310 and the counter substrate 370 is provided over the partition wall 328.

### <<Structure of Image Signal Line Driver Circuit>>

The image signal line driver circuit 303s(1) includes a transistor 303t and a capacitor 303c. Note that the driver circuit can be formed in the same process and over the same substrate as those of the pixel circuits. As illustrated in FIG. 26B, the transistor 303t may include a second gate over the insulating film 321. The second gate may be electrically connected to a gate of the transistor 303t, or different potentials may be supplied thereto. The second gate may be provided in a transistor 308t, the transistor 302t, or the like if necessary.

### <<Structure of Imaging Pixel>>

The imaging pixels 308 each include a photoelectric conversion element 308p and an imaging pixel circuit for sensing light received by the photoelectric conversion element 308p. The imaging pixel circuit includes a transistor 308t.

For example, a PIN photodiode can be used as the photoelectric conversion element 308p.

### <<Structures of Other Components>>

The touch panel 300 includes a wiring 311 through which a signal is supplied. The wiring 311 is provided with a terminal 319. Note that an FPC 309(1) through which a signal such as an image signal or a synchronization signal is supplied is electrically connected to the terminal 319.

Note that a printed wiring board (PWB) may be attached to the FPC 309(1).

Transistors formed in the same process can be used as the transistor 302t, the transistor 303t, and the transistor 308t, and the like.

Transistors of a bottom-gate type, a top-gate type, or the like can be used.

As a gate, a source, and a drain of a transistor, and a wiring or an electrode included in a touch panel, a single-layer structure or a layered structure using any of metals such as aluminum, titanium, chromium, nickel, copper, yttrium, zirconium, molybdenum, silver, tantalum, and tungsten, or an alloy containing any of these metals as its main component can be used. For example, a single-layer structure of an aluminum film containing silicon, a two-layer structure in which an aluminum film is stacked over a titanium film, a two-layer structure in which an aluminum film is stacked over a tungsten film, a two-layer structure in which a copper film is stacked over a copper-magnesium-aluminum alloy film, a two-layer structure in which a copper film is stacked over a titanium film, a two-layer structure in which a copper film is stacked over a tungsten film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used. Copper containing manganese is preferably used because controllability of a shape by etching is increased.

For example, silicon is preferably used as a semiconductor in which a channel of a transistor such as the transistor 302t, the transistor 303t, or the transistor 308t is formed. Although amorphous silicon may be used as silicon, silicon having crystallinity is particularly preferably used. For example, microcrystalline silicon, polycrystalline silicon, single crystal silicon, or the like is preferably used. In particular, polycrystalline silicon can be formed at a lower temperature than single crystal silicon and has higher field effect mobility and higher reliability than amorphous silicon. When such a polycrystalline semiconductor is used for a pixel, the aperture ratio of the pixel can be improved. Even in the case where pixels are provided at extremely high resolution, a gate driver circuit and a source driver circuit can be formed over a substrate over which the pixels are formed, and the number of components of an electronic device can be reduced.

Here, an oxide semiconductor is preferably used for semiconductor devices such as transistors used for pixels included in display regions or driver circuits in a display device. In particular, an oxide semiconductor having a wider band gap than silicon is preferably used. A semiconductor material having a wider band gap and a lower carrier density than silicon is preferably used because off-state leakage current of the transistor can be reduced.

The oxide semiconductor preferably contains at least indium (In) or zinc (Zn), for example. The oxide semiconductor more preferably contains an In-M-Zn-based oxide (M is a metal such as Al, Ti, Ga, Ge, Y, Zr, Sn, La, Ce, or Hf).

As the semiconductor layer, it is particularly preferable to use an oxide semiconductor film including a plurality of crystal parts whose c-axes are aligned perpendicular to a surface on which the semiconductor layer is formed or the top surface of the semiconductor layer and in which the adjacent crystal parts have no grain boundary.

There is no grain boundary in such an oxide semiconductor; therefore, generation of a crack in an oxide semiconductor film that is caused by stress when a display panel is bent is prevented. Such an oxide semiconductor can thus be preferably used for a flexible display panel that is used in a bent state, or the like.

The use of such materials for the semiconductor layer makes it possible to provide a highly reliable transistor in which a change in the electrical characteristics is suppressed.

Charge accumulated in a capacitor through a transistor can be held for a long time because of the low off-state current of the transistor. When such a transistor is used for a pixel, operation of a driver circuit can be stopped while a gray scale of an image displayed in each display region is maintained. As a result, an electronic device with an extremely low power consumption can be obtained.

Note that the details of a preferable mode and a formation method of an oxide semiconductor that can be used for the semiconductor layer will be described in the embodiments below.

Here, a method for forming a flexible light-emitting panel will be described.

Here, a structure including a pixel and a driver circuit or a structure including an optical member such as a color filter is referred to as an element layer for convenience. An element layer includes a display element, for example, and may include a wiring electrically connected to a display element or an element such as a transistor used in a pixel or a circuit in addition to the display element.

Here, a support provided with an insulating surface over which an element layer is formed is called a base material.

As a method for forming an element layer over a flexible base material provided with an insulating surface, there are a method in which an element layer is formed directly over a base material, and a method in which an element layer is formed over a supporting base material that is different from a base material and has stiffness and then the element layer is separated from the supporting base material and transferred to the base material.

In the case where a material of the base material can withstand heating temperature in the process for forming the element layer, it is preferred that the element layer be formed directly over the base material, in which case a manufacturing process can be simplified. At this time, the element layer is preferably formed in a state where the base material is fixed to the supporting base material, in which case the transfer of the element layer in a device and between devices can be easy.

In the case of employing the method in which the element layer is formed over the supporting base material and then transferred to the base material, first, a separation layer and an insulating layer are stacked over a supporting base material, and then the element layer is formed over the insulating layer. Then, the element layer is separated from the supporting base material and then transferred to the base material. At this time, a material is selected such that separation at an interface between the supporting base material and the separation layer, at an interface between the separation layer and the insulating layer, or in the separation layer occurs.

For example, it is preferred that a stack of a layer including a high-melting-point metal material, such as tungsten, and a layer including an oxide of the metal material be used as the separation layer, and a stack of a plurality of layers, such as a silicon nitride layer and a silicon oxynitride layer, be used over the separation layer. The use of the high-melting-point metal material is preferable because the degree of freedom of the process for forming the element layer can be increased.

The separation may be performed by application of mechanical power, by etching of the separation layer, by dripping of liquid into part of the separation interface so that it penetrates the entire separation interface, or the like. Alternatively, separation may be performed by heating the separation interface by utilizing a difference in the thermal expansion coefficient.

The separation layer is not necessarily provided in the case where separation can occur at an interface between the supporting base material and the insulating layer. For example, glass may be used as the supporting base material, an organic resin such as polyimide may be used as the insulating layer, a separation trigger may be formed by locally heating part of the organic resin by laser light or the like, and separation may be performed at an interface between the glass and the insulating layer. Alternatively, a metal layer may be provided between the supporting base material and the insulating layer formed of an organic resin, and separation may be performed at an interface between the metal layer and the insulating layer by heating the metal layer by feeding current to the metal layer. In that case, the insulating layer formed of an organic resin can be used as a base material.

Examples of such a flexible base material include polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, and a polyvinyl chloride resin. In particular, a material whose thermal expansion coefficient is low, for example, lower than or equal to 30×10⁻⁶/K is preferably used, and a polyamide imide resin, a polyimide resin, PET, or the like can suitably be used. Alternatively, a substrate in which a fibrous body is impregnated with a resin (also referred to as prepreg) or a substrate whose thermal expansion coefficient is reduced by mixing an inorganic filler with an organic resin can be used.

In the case where a fibrous body is included in the above material, a high-strength fiber of an organic compound or an inorganic compound is used as the fibrous body. The high-strength fiber is specifically a fiber with a high tensile modulus of elasticity or a fiber with a high Young's modulus. Typical examples thereof include a polyvinyl alcohol-based fiber, a polyester-based fiber, a polyamide-based fiber, a polyethylene-based fiber, an aramid-based fiber, a polyparaphenylene benzobisoxazole fiber, a glass fiber, and a carbon fiber. As the glass fiber, glass fiber using E glass, S glass, D glass, Q glass, or the like can be used. These fibers may be used in a state of a woven fabric or a nonwoven fabric, and a structure body in which this fibrous body is impregnated with a resin and the resin is cured may be used as the flexible substrate. The structure body including the fibrous body and the resin is preferably used as the flexible substrate, in which case the reliability against bending or breaking due to local pressure can be increased.

Note that for a display device of one embodiment of the present invention, an active matrix method in which an active element is included in a pixel or a passive matrix method in which an active element is not included in a pixel can be used.

In an active matrix method, as an active element (a non-linear element), not only a transistor but also various active elements (non-linear elements) can be used. For example, an metal insulator metal (MIM), a thin film diode (TFD), or the like can be used. Such an element has few numbers of manufacturing steps; thus, the manufacturing cost can be reduced or yield can be improved. Furthermore, because the size of the element is small, the aperture ratio can be improved, so that power consumption can be reduced or higher luminance can be achieved.

As a method other than the active matrix method, the passive matrix method in which an active element (a non-linear element) is not used may be used. Since an active element (a non-linear element) is not used, the number of manufacturing steps is small, so that the manufacturing cost can be reduced or yield can be improved. Furthermore, since an active element (a non-linear element) is not used, the aperture ratio can be improved, so that power consumption can be reduced or higher luminance can be achieved, for example.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 7

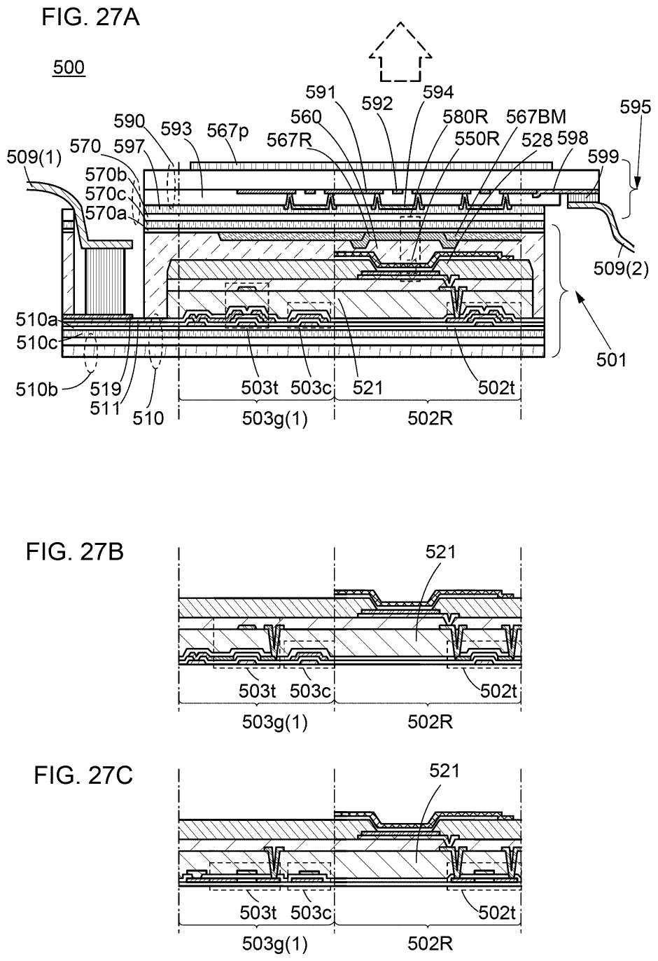

In this embodiment, a structure of a touch panel that can be used in an electronic device of one embodiment of the present invention will be described with reference to FIGS. 27A to 27C. Note that the touch panel may be foldable.

FIGS. 27A to 27C are cross-sectional views of a touch panel 500.

The touch panel 500 includes a display portion 501 and a touch sensor 595. The touch panel 500 further includes a substrate 510, a substrate 570, and a substrate 590. Note that the substrate 510, the substrate 570, and the substrate 590 may each have flexibility.

The display portion 501 includes the substrate 510, a plurality of pixels over the substrate 510, and a plurality of wirings 511 through which signals are supplied to the pixels. The plurality of wirings 511 is led to a peripheral portion of the substrate 510, and part of the plurality of wirings 511 forms a terminal 519. The terminal 519 is electrically connected to an FPC 509(1).

### <Touch Sensor>

The substrate 590 includes the touch sensor 595 and a plurality of wirings 598 electrically connected to the touch sensor 595. The plurality of wirings 598 is led to a peripheral portion of the substrate 590, and part of the plurality of wirings 598 forms a terminal. The terminal is electrically connected to an FPC 509(2).

As the touch sensor 595, a capacitive touch sensor can be used. Examples of the capacitive touch sensor include a surface capacitive touch sensor and a projected capacitive touch sensor.

Examples of the projected capacitive touch sensor include a self capacitive touch sensor and a mutual capacitive touch sensor, which differ mainly in the driving method. The use of a mutual capacitive type is preferable because multiple points can be sensed simultaneously.

The case of using a projected capacitive touch sensor will be described below.

Note that a variety of sensors that can sense the closeness or the contact of a sensing target such as a finger can be used.

The projected capacitive touch sensor 595 includes electrodes 591 and electrodes 592. The electrodes 591 are electrically connected to any of the plurality of wirings 598, and the electrodes 592 are electrically connected to any of the other wirings 598.

A wiring 594 electrically connects two electrodes 591 between which the electrode 592 is positioned. The intersecting area of the electrode 592 and the wiring 594 is preferably as small as possible. Such a structure allows a reduction in the area of a region where the electrodes are not provided, reducing unevenness in transmittance. As a result, unevenness in the luminance of light penetrating the touch sensor 595 can be reduced.

Note that the electrodes 591 and the electrodes 592 can have any of a variety of shapes. For example, the plurality of electrodes 591 may be provided such that space between the electrodes 591 are reduced as much as possible, and the plurality of electrodes 592 may be provided with an insulating layer sandwiched between the electrodes 591 and the electrodes 592 and may be spaced apart from each other to form a region not overlapping with the electrodes 591. In that case, between two adjacent electrodes 592, a dummy electrode that is electrically insulated from these electrodes is preferably provided, whereby the area of a region having a different transmittance can be reduced.

The touch sensor 595 includes the substrate 590, the electrodes 591 and the electrodes 592 provided in a staggered arrangement on the substrate 590, an insulating layer 593 covering the electrodes 591 and the electrodes 592, and the wiring 594 that electrically connects the adjacent electrodes 591.

An adhesive layer 597 bonds the substrate 590 to the substrate 570 such that the touch sensor 595 overlaps with the display portion 501.

The electrodes 591 and the electrodes 592 are formed using a light-transmitting conductive material. As the light-transmitting conductive material, a conductive oxide such as indium oxide, indium tin oxide, indium zinc oxide, zinc oxide, or zinc oxide to which gallium is added, or graphene can be used.

The electrodes 591 and the electrodes 592 can be formed by depositing a light-transmitting conductive material on the substrate 590 by a sputtering method and then removing an unnecessary portion by any of various patterning techniques such as photolithography. Graphene can be formed by a CVD method or in such a manner that a solution in which graphene oxide is dispersed is applied and reduced.

Examples of a material for the insulating layer 593 include resins such as acrylic and an epoxy resin, a resin having a siloxane bond, and inorganic insulating materials such as silicon oxide, silicon oxynitride, and aluminum oxide.

Furthermore, openings reaching the electrodes 591 are formed in the insulating layer 593, and the wiring 594 electrically connects the adjacent electrodes 591. A light-transmitting conductive material can be favorably used for the wiring 594 because the aperture ratio of the touch panel can be increased. Moreover, a material with higher conductivity than those of the electrodes 591 and 592 can be favorably used because electric resistance can be reduced.

One electrode 592 extends in one direction, and the plurality of electrodes 592 is provided in the form of stripes.

The wiring 594 intersects with the electrode 592.

Adjacent electrodes 591 are provided with one electrode 592 provided therebetween. The wiring 594 electrically connects the adjacent electrodes 591.

Note that the plurality of electrodes 591 is not necessarily arranged in the direction orthogonal to one electrode 592 and may be arranged to intersect with one electrode 592 at an angle of less than 90 degrees.

One wiring 598 is electrically connected to any of the electrodes 591 and 592. Part of the wiring 598 serves as a terminal. For the wiring 598, a metal material such as aluminum, gold, platinum, silver, nickel, titanium, tungsten, chromium, molybdenum, iron, cobalt, copper, or palladium or an alloy material containing any of these metal materials can be used.

Note that an insulating layer that covers the insulating layer 593 and the wiring 594 may be provided to protect the touch sensor 595.

A connection layer 599 electrically connects the wiring 598 to the FPC 509(2).

As the connection layer 599, any of anisotropic conductive films (ACF), anisotropic conductive pastes (ACP), and the like can be used.

The adhesive layer 597 has a light-transmitting property. For example, a thermosetting resin or an ultraviolet curable resin can be used; specifically, a resin such as an acrylic resin, an urethane resin, an epoxy resin, or a resin having a siloxane bond can be used.

### <Display Portion>

The display portion 501 includes a plurality of pixels arranged in a matrix. Each of the pixels includes a display element and a pixel circuit for driving the display element.

In this embodiment, an example of using an organic electroluminescent element that emits white light as a display element will be described; however, the display element is not limited to such element. Organic electroluminescent elements for different colors, for example, an organic electroluminescent element for red, an organic electroluminescent element for blue, and an organic electroluminescent element for green may be used.

Other than organic electroluminescent elements, for example, any of various display elements such as display elements (electronic ink) that perform display by an electrophoretic method, an electronic liquid powder method, or the like; MEMS shutter display elements; and optical-interference-type MEMS display elements can be used. Note that a structure suitable for employed display elements can be selected from among a variety of structures of pixel circuits.

The substrate 510 is a stack in which a flexible substrate 510b, a barrier film 510a that prevents diffusion of impurities to light-emitting elements, and an adhesive layer 510c that bonds the barrier film 510a to the substrate 510b are stacked.

The substrate 570 is a stack in which a flexible substrate 570b, a barrier film 570a that prevents diffusion of impurities to the light-emitting elements, and an adhesive layer 570c that bonds the barrier film 570a to the substrate 570b are stacked.

A sealant 560 bonds the substrate 570 to the substrate 510. The sealant 560 has a refractive index higher than that of air. In the case of extracting light to the sealant 560 side, the sealant 560 serves as an optical adhesive layer. The pixel circuits and the light-emitting elements (e.g., a first light-emitting element 550R) are provided between the substrate 510 and the substrate 570.

### <<Pixel Structure>>

The pixel includes a sub-pixel 502R, and the sub-pixel 502R includes a light-emitting module 580R.

The sub-pixel 502R includes the first light-emitting element 550R and the pixel circuit that can supply electric power to the first light-emitting element 550R and includes a transistor 502t. The light-emitting module 580R includes the first light-emitting element 550R and an optical element (e.g., a coloring layer 567R).

The first light-emitting element 550R includes a lower electrode, an upper electrode, and a layer containing a light-emitting organic compound between the lower electrode and the upper electrode.

The light-emitting module 580R includes the first coloring layer 567R on the light extraction side. The coloring layer transmits light with a particular wavelength and is, for example, a layer that selectively transmits red, green, or blue light. Note that in another sub-pixel, a region that transmits light emitted from the light-emitting element as it is may be provided.

In the case where the sealant 560 is provided on the light extraction side, the sealant 560 is in contact with the first light-emitting element 550R and the first coloring layer 567R.

The first coloring layer 567R is positioned in a region overlapping with the first light-emitting element 550R. Accordingly, part of light emitted from the first light-emitting element 550R passes through the first coloring layer 567R and is emitted to the outside of the light-emitting module 580R as indicated by an arrow in FIG. 27A.

### <<Structure of Display Portion>>

The display portion 501 includes a light-blocking layer 567BM on the light extraction side. The light-blocking layer 567BM is provided so as to surround the coloring layer (e.g., the first coloring layer 567R).

The display portion 501 includes an anti-reflective layer 567p positioned in a region overlapping with the pixels. As the anti-reflective layer 567p, a circular polarizing plate can be used, for example.

The display portion 501 includes an insulating film 521. The insulating film 521 covers the transistor 502t. Note that the insulating film 521 can be used as a layer for planarizing unevenness due to the pixel circuit. A layered film including a layer that can prevent diffusion of impurities can be used as the insulating film 521. This can prevent decrease of the reliability of the transistor 502t or the like due to diffusion of impurities.

The display portion 501 includes the light-emitting elements (e.g., the first light-emitting element 550R) over the insulating film 521.

The display portion 501 includes, over the insulating film 521, a partition wall 528 that overlaps with an end portion of the first lower electrode. In addition, a spacer that controls the distance between the substrate 510 and the substrate 570 is provided over the partition wall 528.

### <<Configuration of Scan Line Driver Circuit>>

A scan line driver circuit 503g(1) includes a transistor 503t and a capacitor 503c. Note that the driver circuit can be formed in the same process and over the same substrate as those of the pixel circuits.

### <<Structures of Other Components>>

The display portion 501 includes the wirings 511 through which signals are supplied. The wirings 511 are provided with the terminal 519. Note that the FPC 509(1) through which a signal such as an image signal or a synchronization signal are supplied is electrically connected to the terminal 519.

Note that a printed wiring board (PWB) may be attached to the FPC 509(1).

### <Modification Example 1 of Display Portion>

Any of various kinds of transistors can be used in the display portion 501.

FIGS. 27A and 27B illustrate a structure in which bottom-gate transistors are used in the display portion 501.

For example, a semiconductor layer containing an oxide semiconductor, amorphous silicon, or the like can be used in the transistor 502t and the transistor 503t illustrated in FIG. 27A.

For example, a semiconductor layer containing polycrystalline silicon or the like can be used in the transistor 502t and the transistor 503t illustrated in FIG. 27B.

A structure of the case where top-gate transistors are used in the display portion 501 is illustrated in FIG. 27C.

For example, a semiconductor layer containing polycrystalline silicon, a transferred single crystal silicon film, or the like can be used in the transistor 502t and the transistor 503t illustrated in FIG. 27C.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 8

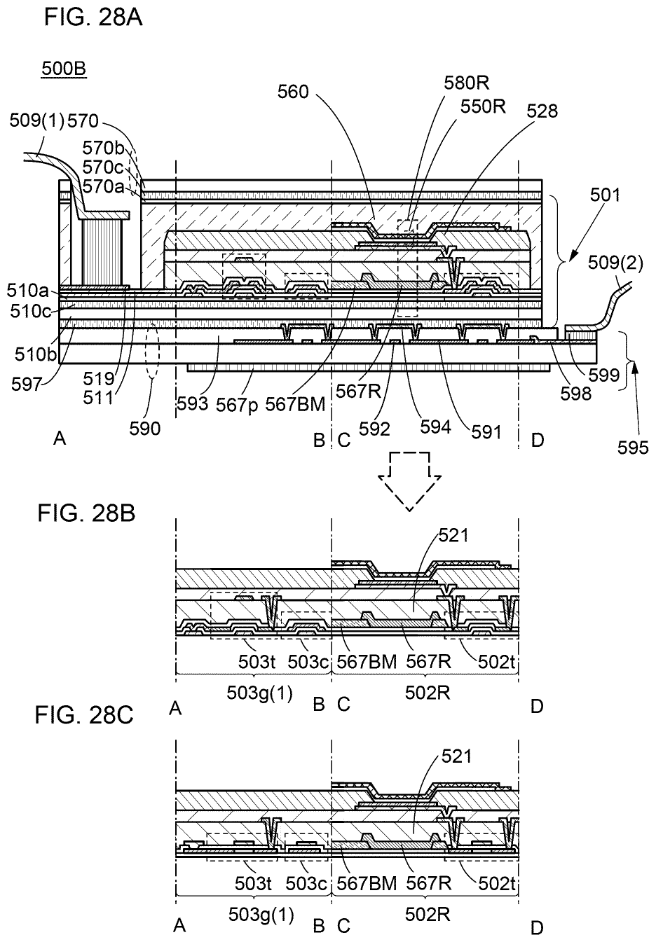

In this embodiment, a structure of a touch panel that can be used in an electronic device of one embodiment of the present invention will be described with reference to FIGS. 28A to 28C. Note that the touch panel may be foldable.

FIGS. 28A to 28C are cross-sectional views of a touch panel 500B.

The touch panel 500B described in this embodiment is different from the touch panel 500 described in Embodiment 7 in that the display portion 501 displays received image data to the side where the transistors are provided and that the touch sensor is provided on the substrate 510 side of the display portion. Different structures will be described in detail below, and the above description is referred to for the other similar structures.

### <Display Portion>

The display portion 501 includes a plurality of pixels arranged in a matrix. Each of the pixels includes a display element and a pixel circuit for driving the display element.

### <<Pixel Structure>>

A pixel includes a sub-pixel 502R, and the sub-pixel 502R includes a light-emitting module 580R.

The sub-pixel 502R includes the first light-emitting element 550R and the pixel circuit that can supply electric power to the first light-emitting element 550R and includes a transistor 502t.

The light-emitting module 580R includes the first light-emitting element 550R and an optical element (e.g., the coloring layer 567R).

The first light-emitting element 550R includes a lower electrode, an upper electrode, and a layer containing a light-emitting organic compound between the lower electrode and the upper electrode.

The light-emitting module 580R includes the first coloring layer 567R on the light extraction side. The coloring layer transmits light with a particular wavelength and is, for example, a layer that selectively transmits red, green, or blue light. Note that in another sub-pixel, a region that transmits light emitted from the light-emitting element as it is may be provided.

The first coloring layer 567R is positioned in a region overlapping with the first light-emitting element 550R. The first light-emitting element 550R illustrated in FIG. 28A emits light to the side where the transistor 502t is provided. Accordingly, part of light emitted from the first light-emitting element 550R passes through the first coloring layer 567R and is emitted to the outside of the light-emitting module 580R as indicated by an arrow in FIG. 28A.

### <<Structure of Display Portion>>

The display portion 501 includes a light-blocking layer 567BM on the light extraction side. The light-blocking layer 567BM is provided so as to surround the coloring layer (e.g., the first coloring layer 567R).

The display portion 501 includes an insulating film 521. The insulating film 521 covers the transistor 502t. Note that the insulating film 521 can be used as a layer for planarizing unevenness due to the pixel circuit. A layered film including a layer that can prevent diffusion of impurities can be used as the insulating film 521. This can prevent the decrease of the reliability of the transistor 502t or the like due to diffusion of impurities from the coloring layer 567R.

### <Touch Sensor>

The touch sensor 595 is provided on the substrate 510 side of the display portion 501 (see FIG. 28A).

The adhesive layer 597 is provided between the substrate 510 and the substrate 590 and bonds the touch sensor 595 to the display portion 501.

### <Modification Example 1 of Display Portion>

Any of various kinds of transistors can be used in the display portion 501.

FIGS. 28A and 28B illustrate a structure of the case where bottom-gate transistors are used in the display portion 501.

For example, a semiconductor layer containing an oxide semiconductor, amorphous silicon, or the like can be used in the transistor 502t and the transistor 503t illustrated in FIG. 28A.

For example, a semiconductor layer containing polycrystalline silicon or the like can be used in the transistor 502t and the transistor 503t illustrated in FIG. 28B.

FIG. 28C illustrates a structure of the case where top-gate transistors are used in the display portion 501.

For example, a semiconductor layer containing polycrystalline silicon, a transferred single crystal silicon film, or the like can be used in the transistor 502t and the transistor 503t illustrated in FIG. 28C.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 9

An oxide semiconductor suitable for a semiconductor layer of a semiconductor device that can be used for a display panel of one embodiment of the present invention will be described in this embodiment.

An oxide semiconductor has a wide energy gap of 3.0 eV or more. A transistor including an oxide semiconductor film obtained by processing of the oxide semiconductor under an appropriate condition and sufficiently reducing the carrier density of the oxide semiconductor can have much lower leakage current between a source and a drain in an off state (off-state current) than a conventional transistor including silicon.

An applicable oxide semiconductor preferably contains at least indium (In) or zinc (Zn). In particular, In and Zn are preferably contained. In addition, as a stabilizer for reducing variation in the electric characteristics of the transistor using the oxide semiconductor, one or more selected from gallium (Ga), tin (Sn), hafnium (Hf), zirconium (Zr), titanium (Ti), scandium (Sc), yttrium (Y), and an lanthanoid (such as cerium (Ce), neodymium (Nd), or gadolinium (Gd)) is preferably contained.

As the oxide semiconductor, for example, any of the following can be used: indium oxide, tin oxide, zinc oxide, an In-Zn-based oxide, a Sn-Zn-based oxide, an Al-Zn-based oxide, a Zn-Mg-based oxide, a Sn-Mg-based oxide, an In-Mg-based oxide, an In-Ga-based oxide, an In-Ga-Zn-based oxide (also referred to as IGZO), an In-Al-Zn-based oxide, an In-Sn-Zn-based oxide, a Sn-Ga-Zn-based oxide, an Al-Ga-Zn-based oxide, a Sn-Al-Zn-based oxide, an In-Hf-Zn-based oxide, an In-Zr-Zn-based oxide, an In-Ti-Zn-based oxide, an In-Sc-Zn-based oxide, an In-Y-Zn-based oxide, an In-La-Zn-based oxide, an In-Ce-Zn-based oxide, an In-Pr-Zn-based oxide, an In-Nd-Zn-based oxide, an In-Sm-Zn-based oxide, an In-Eu-Zn-based oxide, an In-Gd-Zn-based oxide, an In-Tb-Zn-based oxide, an In-Dy-Zn-based oxide, an In-Ho-Zn-based oxide, an In-Er-Zn-based oxide, an In-Tm-Zn-based oxide, an In-Yb-Zn-based oxide, an In-Lu-Zn-based oxide, an In-Sn-Ga-Zn-based oxide, an In-Hf-Ga-Zn-based oxide, an In-Al-Ga-Zn-based oxide, an In-Sn-Al-Zn-based oxide, an In-Sn-Hf-Zn-based oxide, and an In-Hf-Al-Zn-based oxide.

Here, an “In-Ga-Zn-based oxide” means an oxide containing In, Ga, and Zn as its main components and there is no particular limitation on the ratio of In:Ga:Zn. The In-Ga-Zn-based oxide may contain another metal element in addition to In, Ga, and Zn.

Alternatively, a material represented by InMO₃(ZnO)ₘ (m>0 is satisfied, and m is not an integer) may be used as an oxide semiconductor. Note that M represents one or more metal elements selected from Ga, Fe, Mn, and Co, or the above-described element as a stabilizer. Alternatively, as the oxide semiconductor, a material represented by In₂SnO₅(ZnO)ₙ (n>0, n is an integer) may be used.

For example, an In-Ga-Zn-based oxide with an atomic ratio of In:Ga:Zn=1:1:1, 1:3:2, 1:3:4, 1:3:6, 3:1:2, or 2:1:3, or an oxide whose composition is in the neighborhood of the above compositions may be used.

When the oxide semiconductor film contains a large amount of hydrogen, the hydrogen and an oxide semiconductor are bonded to each other, so that part of the hydrogen serves as a donor and causes generation of an electron serving as a carrier. As a result, the threshold voltage of the transistor shifts in the negative direction. Therefore, it is preferred that, after formation of the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. As described above, it is preferred that, after formation of the oxide semiconductor film, the dehydration treatment (dehydrogenation treatment) be performed to remove hydrogen or moisture from the oxide semiconductor film, so that the oxide semiconductor film is highly purified to contain impurities as little as possible, and that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, and treatment for making the oxygen content of an oxide semiconductor film be in excess of that in the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film, which is extremely close to an i-type oxide semiconductor film. Note that “substantially intrinsic” means that the oxide semiconductor film contains extremely few (close to zero) carriers derived from a donor and has a carrier density of higher than or equal to 1×10⁻⁹/cm³ and lower than or equal to 1×10¹⁷ /cm³, lower than or equal to 1×10¹⁶ /cm³, lower than or equal to 1×10¹⁵ /cm³, lower than or equal to 1×10¹⁴ /cm³, or lower than or equal to 1×10¹³ /cm³, particularly preferably lower than 8×10¹¹ /cm³, still further preferably lower than 1×10¹¹ /cm³, yet further preferably lower than 1×10¹⁰ /cm³.

Thus, the transistor including an i-type or substantially i-type oxide semiconductor film can have significantly excellent off-state current characteristics. For example, the drain current at the time when the transistor including an oxide semiconductor film is in an off-state can be less than or equal to 1×10⁻¹⁸ A, preferably less than or equal to 1×10⁻²¹ A, more preferably less than or equal to 1×10⁻²⁴ A at room temperature (approximately 25° C.); or less than or equal to 1×10⁻¹⁵ A, preferably less than or equal to 1×10⁻¹⁸ A, more preferably less than or equal to 1×10⁻²¹ A at 85° C. Note that an off state of an n-channel transistor refers to a state where the gate voltage is sufficiently lower than the threshold voltage. Specifically, the transistor is in an off state when the gate voltage is lower than the threshold voltage by 1 V or more, 2 V or more, or 3 V or more. Note that these current values are values when the voltage between a source and a drain is, for example, 1 V, 5 V, or 10 V.

A structure of the oxide semiconductor film will be described below.

An oxide semiconductor film is classified roughly into a single-crystal oxide semiconductor film and a non-single-crystal oxide semiconductor film. The non-single-crystal oxide semiconductor film includes any of a c-axis aligned crystalline oxide semiconductor (CAAC-OS) film, a polycrystalline oxide semiconductor film, a microcrystalline oxide semiconductor film, an amorphous oxide semiconductor film, and the like.

First, a CAAC-OS film will be described. Note that a CAAC-OS can be referred to as an oxide semiconductor including c-axis aligned nanocrystals (CANC).

The CAAC-OS film is one of oxide semiconductor films having a plurality of c-axis aligned crystal parts.

In a transmission electron microscope (TEM) image of the CAAC-OS film, a boundary between crystal parts, that is, a grain boundary is not clearly observed. Thus, in the CAAC-OS film, a reduction in electron mobility due to the grain boundary is less likely to occur.

According to the TEM image of the CAAC-OS film observed in the direction substantially parallel to a sample surface (cross-sectional TEM image), metal atoms are arranged in a layered manner in the crystal parts. Each metal atom layer has a morphology reflected by a surface over which the CAAC-OS film is formed (hereinafter, a surface over which the CAAC-OS film is formed is referred to as a formation surface) or the top surface of the CAAC-OS film, and is arranged in parallel to the formation surface or the top surface of the CAAC-OS film.

On the other hand, according to the TEM image of the CAAC-OS film observed in the direction substantially perpendicular to the sample surface (plan TEM image), metal atoms are arranged in a triangular or hexagonal configuration in the crystal parts. However, there is no regularity of arrangement of metal atoms between different crystal parts.

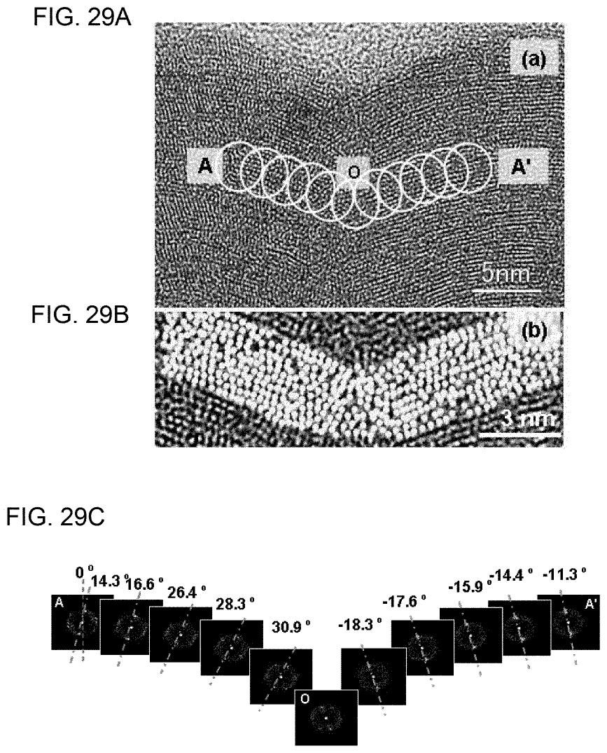

FIG. 29a is a cross-sectional TEM image of a CAAC-OS film. FIG. 29b is a cross-sectional TEM image obtained by enlarging the image of FIG. 29a. In FIG. 29b, atomic arrangement is highlighted for easy understanding.

FIG. 29c is Fourier transform images of regions each surrounded by a circle (the diameter is approximately 4 nm) between A and O and between O and A′ in FIG. 29a. c-axis alignment can be observed in each region in FIG. 29c. The c-axis direction between A and O is different from that between O and A′, which indicates that a grain in the region between A and O is different from that between O and A′. In addition, between A and O, the angle of the c-axis continuously and gradually changes from 14.3°, 16.6° to 26.4°. Similarly, between O and A′, the angle of the c-axis continuously changes from −18.3°, −17.6°, to −15.9°.

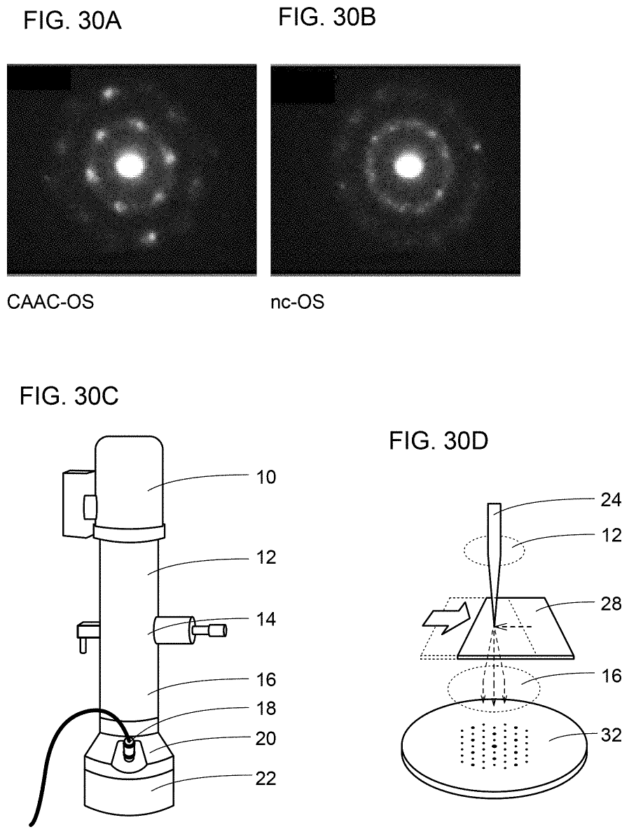

Note that in an electron diffraction pattern of the CAAC-OS film, spots (bright spots) having alignment are shown. For example, spots are observed in an electron diffraction pattern (also referred to as a nanobeam electron diffraction pattern) of the top surface of the CAAC-OS film which is obtained using an electron beam with a diameter of, for example, larger than or equal to 1 nm and smaller than or equal to 30 nm (see FIG. 30A).

From the results of the cross-sectional TEM image and the plan TEM image, alignment is found in the crystal parts in the CAAC-OS film.

Most of the crystal parts included in the CAAC-OS film each fit inside a cube whose one side is less than 100 nm. Thus, there is a case where a crystal part included in the CAAC-OS film fits inside a cube whose one side is less than 10 nm, less than 5 nm, or less than 3 nm. Note that when a plurality of crystal parts included in the CAAC-OS film are connected to each other, one large crystal region is formed in some cases. For example, a crystal region with an area of 2500 nm² or more, 5 μm² or more, or 1000 μm² or more is observed in some cases in the plan TEM image.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in the direction substantially perpendicular to the formation surface or the top surface of the CAAC-OS film.

On the other hand, when the CAAC-OS film is analyzed by an in-plane method in which an X-ray enters a sample in the direction substantially perpendicular to the c-axis, a peak appears frequently when 2θ is around 56°. This peak is derived from the (110) plane of the InGaZnO₄ crystal. Here, analysis (ϕ scan) is performed under conditions where the sample is rotated around a normal vector of a sample surface as an axis (ϕ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when θ scan is performed with 2θ fixed at around 56°.

According to the above results, in the CAAC-OS film having c-axis alignment, while the directions of a-axes and b-axes are different between crystal parts, the c-axes are aligned in the direction parallel to a normal vector of the formation surface or a normal vector of the top surface of the CAAC-OS film. Thus, each metal atom layer arranged in a layered manner observed in the cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned in the direction parallel to a normal vector of the formation surface or a normal vector of the top surface of the CAAC-OS film. Thus, for example, in the case where a shape of the CAAC-OS film is changed by etching or the like, the c-axis of the crystal might not be necessarily parallel to a normal vector of the formation surface or a normal vector of the top surface of the CAAC-OS film.

Further, the distribution of c-axis aligned crystal parts in the CAAC-OS film is not necessarily uniform. For example, in the case where crystal growth leading to the CAAC-OS film occurs from the vicinity of the top surface of the film, the proportion of the c-axis aligned crystal parts in the vicinity of the top surface is higher than that in the vicinity of the formation surface in some cases. Further, in the CAAC-OS film to which an impurity is added, an impurity-added region is altered, and the proportion of the c-axis aligned crystal parts in the CAAC-OS film varies depending on regions, in some cases.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in part of the CAAC-OS film. It is preferred that in the CAAC-OS film, a peak of 2θ appear at around 31° and a peak of 2θ not appear at around 36°.

The CAAC-OS film is an oxide semiconductor film having a low impurity concentration. The impurity is an element other than the main components of the oxide semiconductor film, such as hydrogen, carbon, silicon, and a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Further, heavy metals such as iron and nickel, argon, carbon dioxide, and the like each have a large atomic radius (molecular radius), and thus disturb the atomic arrangement of the oxide semiconductor film and causes a decrease in crystallinity when any of them is contained in the oxide semiconductor film. Note that the impurity contained in the oxide semiconductor film might serve as a carrier trap or a carrier generation source.

Further, the CAAC-OS film is an oxide semiconductor film having a low density of defect states. For example, oxygen vacancies in the oxide semiconductor film serve as carrier traps or serve as carrier generation sources in some cases when hydrogen is captured therein.

The state in which the impurity concentration is low and the density of defect states is low (the number of oxygen vacancies is small) is referred to as a highly purified intrinsic state or a substantially highly purified intrinsic state. A highly purified intrinsic or substantially highly purified intrinsic oxide semiconductor film has few carrier generation sources, and thus can have a low carrier density. Thus, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has small variations in electrical characteristics and high reliability. Electric charge trapped by the carrier traps in the oxide semiconductor film takes a long time to be released, and might behave like fixed electric charge. Thus, a transistor including an oxide semiconductor film having a high impurity concentration and a high density of defect states has unstable electrical characteristics in some cases.

In a transistor using the CAAC-OS film, a change in electrical characteristics due to irradiation with visible light or ultraviolet light is small.

Next, a microcrystalline oxide semiconductor film will be described.

In an image obtained with TEM, crystal parts cannot be found clearly in the microcrystalline oxide semiconductor film in some cases. In most cases, the size of a crystal part in the microcrystalline oxide semiconductor film is greater than or equal to 1 nm and less than or equal to 100 nm, or greater than or equal to 1 nm and less than or equal to 10 nm. A microcrystal with a size greater than or equal to 1 nm and less than or equal to 10 nm or a size greater than or equal to 1 nm and less than or equal to 3 nm is specifically referred to as nanocrystal (nc). An oxide semiconductor film including a nanocrystal is referred to as a nanocrystalline oxide semiconductor (nc-OS) film. In an image obtained with TEM, a crystal grain boundary cannot be found clearly in the nc-OS film in some cases. Note that the nc-OS can also be referred to as an oxide semiconductor including random aligned nanocrystals (RANC) or an oxide semiconductor including non-aligned nanocrystals (NANC).

In the nc-OS film, a microscopic region (for example, a region with a size greater than or equal to 1 nm and less than or equal to 10 nm, in particular, a region with a size greater than or equal to 1 nm and less than or equal to 3 nm) has a periodic atomic order. Further, there is no regularity of crystal orientation between different crystal parts in the nc-OS film; thus, the orientation of the whole film is not observed. Accordingly, in some cases, the nc-OS film cannot be distinguished from an amorphous oxide semiconductor film depending on an analysis method. For example, when the nc-OS film is subjected to structural analysis by an out-of-plane method with an XRD apparatus using an X-ray having a diameter larger than a crystal part, a peak which shows a crystal plane does not appear. Further, a halo pattern is shown in a selected-area electron diffraction pattern of the nc-OS film which is obtained by using an electron beam having a probe diameter (e.g., larger than or equal to 50 nm) larger than the diameter of a crystal part. In contrast, spots are shown in a nanobeam electron diffraction pattern of the nc-OS film which is obtained by using an electron beam having a probe diameter close to, or smaller than or equal to the diameter of a crystal part. Further, in a nanobeam electron diffraction pattern of the nc-OS film, regions with high luminance in a circular (ring) pattern are shown in some cases. Also in a nanobeam electron diffraction pattern of the nc-OS film, a plurality of spots are shown in a ring-like region in some cases (see FIG. 30B).

The nc-OS film is an oxide semiconductor film that has higher regularity than an amorphous oxide semiconductor film. Therefore, the nc-OS film has a lower density of defect states than an amorphous oxide semiconductor film. Note that there is no regularity of crystal orientation between different crystal parts in the nc-OS film; hence, the nc-OS film has a higher density of defect states than the CAAC-OS film.

Note that an oxide semiconductor film may be a stack including two or more of an amorphous oxide semiconductor film, a microcrystalline oxide semiconductor film, and a CAAC-OS film, for example.

In the case where the oxide semiconductor film has a plurality of structures, the structures can be analyzed using nanobeam electron diffraction in some cases.

FIG. 30C illustrates a transmission electron diffraction measurement apparatus that includes an electron gun chamber 10, an optical system 12 below the electron gun chamber 10, a sample chamber 14 below the optical system 12, an optical system 16 below the sample chamber 14, an observation chamber 20 below the optical system 16, a camera 18 installed in the observation chamber 20, and a film chamber 22 below the observation chamber 20. The camera 18 is provided to face the inside of the observation chamber 20. Note that the film chamber 22 is not necessarily provided.

FIG. 30D illustrates an internal structure of the transmission electron diffraction measurement apparatus illustrated in FIG. 30C. In the transmission electron diffraction measurement apparatus, a substance 28 provided in the sample chamber 14 is irradiated with electrons ejected from an electron gun provided in the electron gun chamber 10 through the optical system 12. The electrons that have passed through the substance 28 enter a fluorescent plate 32 provided in the observation chamber 20 through the optical system 16. On the fluorescent plate 32, a pattern corresponding to the intensity of electron that has entered fluorescent plate 32 appears, which allows measurement of a transmission electron diffraction pattern.

The camera 18 is set toward the fluorescent plate 32 so that a pattern on the fluorescent plate 32 can be taken. An angle formed by a straight line that passes through the center of a lens of the camera 18 and the center of the fluorescent plate 32 and an upper surface of the fluorescent plate 32 is, for example, 15° or more and 80° or less, 30° or more and 75° or less, or 45° or more and 70° or less. As the angle is reduced, distortion of the transmission electron diffraction pattern taken by the camera 18 becomes larger. Note that if the angle is obtained in advance, the distortion of an obtained transmission electron diffraction pattern can be corrected. Note that the film chamber 22 may be provided with the camera 18. For example, the camera 18 may be set in the film chamber 22 so as to be opposite to the incident direction of electrons 24. In that case, a transmission electron diffraction pattern with less distortion can be taken from the rear surface of the fluorescent plate 32.

A holder for fixing the substance 28, which is a sample, is provided in the sample chamber 14. The holder transmits electrons passing through the substance 28. The holder may have, for example, a function of moving the substance 28 in the direction of the X, Y, and Z axes. The movement function of the holder has an accuracy of moving the substance, for example, in the range from 1 nm to 10 nm, from 5 nm to 50 nm, from 10 nm to 100 nm, from 50 nm to 500 nm, and from 100 nm to 1 μm. The range is determined to be an optimal range for the structure of the substance 28.

Next, a method for measuring a transmission electron diffraction pattern of a substance by the transmission electron diffraction measurement apparatus described above will be described.

For example, changes in the structure of a substance can be observed by changing (scanning) the irradiation position of the electrons 24, which are a nanobeam in the substance, as illustrated in FIG. 30D. At this time, when the substance 28 is a CAAC-OS film, such a diffraction pattern as is shown in FIG. 30A is observed. When the substance 28 is an nc-OS film, a diffraction pattern shown in FIG. 30B is observed.

Even when the substance 28 is a CAAC-OS film, a diffraction pattern similar to that of an nc-OS film or the like is partly observed in some cases. Therefore, whether or not a CAAC-OS film is favorable can be determined by the proportion of a region where a diffraction pattern of a CAAC-OS film is observed in a predetermined area (also referred to as the proportion of CAAC). In the case of a high-quality CAAC-OS film, for example, the proportion of CAAC is higher than or equal to 50%, preferably higher than or equal to 80%, more preferably higher than or equal to 90%, still more preferably higher than or equal to 95%. Note that the proportion of an area where a diffraction pattern different from that of a CAAC-OS film is observed is referred to as the proportion of non-CAAC.

For example, transmission electron diffraction patterns were obtained by scanning a top surface of a sample including a CAAC-OS film obtained just after deposition (represented as “as-sputtered”) and a top surface of a sample including a CAAC-OS film subjected to heat treatment at 450° C. in an atmosphere containing oxygen. Here, the proportion of CAAC was obtained in such a manner that diffraction patterns were observed by performing scanning for 60 seconds at a rate of 5 nm/second and the obtained diffraction patterns were converted into still images every 0.5 seconds. Note that as an electron beam, a nanobeam with a probe diameter of 1 nm was used. The above measurement was performed on six samples. The proportion of CAAC was calculated using the average value of the six samples.

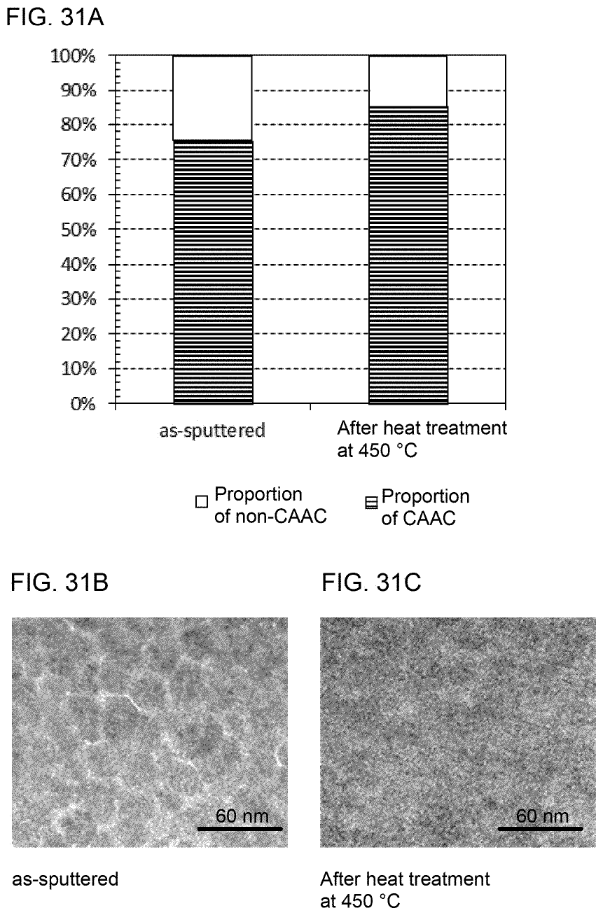

FIG. 31A shows the proportion of CAAC in each sample. The proportion of CAAC of the CAAC-OS film obtained just after the deposition is 75.7% (the proportion of non-CAAC is 24.3%). The proportion of CAAC of the CAAC-OS film subjected to the heat treatment at 450° C. is 85.3% (the proportion of non-CAAC is 14.7%). These results show that the proportion of CAAC obtained after the heat treatment at 450° C. is higher than that obtained just after the deposition. That is, heat treatment at a high temperature (e.g., higher than or equal to 400° C.) reduces the proportion of non-CAAC (increases the proportion of CAAC). The above results also indicate that even when the temperature of the heat treatment is lower than 500° C., the CAAC-OS film can have a high proportion of CAAC.

Here, most of diffraction patterns different from that of a CAAC-OS film are diffraction patterns similar to that of an nc-OS film. In addition, an amorphous oxide semiconductor film was not able to be observed in the measurement area. Therefore, the above results suggest that the region having a structure similar to that of an nc-OS film is rearranged by the heat treatment owing to the influence of the structure of the adjacent area, whereby the area becomes CAAC.

FIGS. 31B and 31C are planar TEM images of the CAAC-OS film obtained just after the deposition and the CAAC-OS film subjected to the heat treatment at 450° C., respectively. Comparison between FIGS. 31B and 31C shows that the CAAC-OS film subjected to the heat treatment at 450° C. has more uniform film quality. This implies that the heat treatment at a high temperature improves the film quality of the CAAC-OS film.

With such a measurement method, the structure of an oxide semiconductor film having a plurality of structures can be analyzed in some cases.

The CAAC-OS film is formed, for example, by the following method.

For example, the CAAC-OS film is formed by a sputtering method with a polycrystalline oxide semiconductor sputtering target.

By increasing the substrate temperature during the deposition, migration of sputtered particles occurs after the sputtered particles reach a substrate surface. Specifically, the substrate temperature during the deposition is higher than or equal to 100° C. and lower than or equal to 740° C., preferably higher than or equal to 200° C. and lower than or equal to 500° C. By increasing the substrate temperature during the deposition, when the sputtered particles reach the substrate, migration occurs on the substrate surface, so that a flat plane of the sputtered particles is attached to the substrate. At this time, the sputtered particle is charged positively, whereby sputtered particles are attached to the substrate while repelling each other; thus, the sputtered particles do not overlap with each other randomly, and a CAAC-OS film with a uniform thickness can be formed.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in the deposition chamber may be reduced. Furthermore, the concentration of impurities in a deposition gas may be reduced. Specifically, a deposition gas whose dew point is −80° C. or lower, preferably −100° C. or lower is used.

Furthermore, it is preferred that the proportion of oxygen in the deposition gas be increased and the power be optimized in order to reduce plasma damage at the deposition. The proportion of oxygen in the deposition gas is higher than or equal to 30 vol %, preferably 100 vol %.

Alternatively, the CAAC-OS film is formed by the following method.

First, a first oxide semiconductor film is formed to a thickness of greater than or equal to 1 nm and less than 10 nm. The first oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that the first oxide semiconductor film becomes a first CAAC-OS film with high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferred that heat treatment in an inert atmosphere and heat treatment in an oxidation atmosphere be performed in this order. The heat treatment in an inert atmosphere can reduce the concentration of impurities in the first oxide semiconductor film in a short time. At the same time, the heat treatment in an inert atmosphere might generate oxygen vacancies in the first oxide semiconductor film. In that case, the heat treatment in an oxidation atmosphere can reduce the oxygen vacancies. Note that the heat treatment may be performed under a reduced pressure of, for example, 1000 Pa or lower, 100 Pa or lower, 10 Pa or lower, or 1 Pa or lower. The heat treatment under the reduced pressure can reduce the concentration of impurities in the first oxide semiconductor film in a shorter time.

The first oxide semiconductor film can be crystallized easier in the case where the thickness is greater than or equal to 1 nm and less than 10 nm than in the case where the thickness is greater than or equal to 10 nm.

Next, a second oxide semiconductor film having the same composition as the first oxide semiconductor film is formed to a thickness of greater than or equal to 10 nm and less than or equal to 50 nm. The second oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that solid phase growth of the second oxide semiconductor film is performed using the first CAAC-OS film, thereby forming a second CAAC-OS film with high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferred that heat treatment in an inert atmosphere and heat treatment in an oxidation atmosphere be performed in this order.

The heat treatment in an inert atmosphere can reduce the concentration of impurities in the second oxide semiconductor film in a short time. At the same time, the heat treatment in an inert atmosphere might generate oxygen vacancies in the second oxide semiconductor film. In that case, the heat treatment in an oxidation atmosphere can reduce the oxygen vacancies. Note that the heat treatment may be performed under a reduced pressure of, for example, 1000 Pa or lower, 100 Pa or lower, 10 Pa or lower, or 1 Pa or lower. The heat treatment under the reduced pressure can reduce the concentration of impurities in the second oxide semiconductor film in a shorter time.

In the above-described manner, a CAAC-OS film with a total thickness of greater than or equal to 10 nm can be formed.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

### Embodiment 10

In the other embodiments, a variety of examples are described. Note that one embodiment of the present invention is not limited to the above examples.

In this specification and the like, for example, transistors with a variety of structures can be used as a transistor, without limitation to a certain type. For example, a transistor including a single-crystal silicon or a non-single-crystal semiconductor film typified by amorphous silicon, polycrystalline silicon, microcrystalline (also referred to as microcrystal, nanocrystal, or semi-amorphous) silicon, or the like can be used as a transistor. Alternatively, a thin film transistor (TFT) whose semiconductor film is thinned can be used. In the case of using the TFT, there are various advantages. For example, since the TFT can be formed at temperature lower than that of the case of using single-crystal silicon, manufacturing cost can be reduced or a manufacturing apparatus can be made larger. Since the manufacturing apparatus can be made larger, the TFT can be formed using a large substrate. Therefore, many display devices can be formed at the same time at low cost. In addition, a substrate having low heat resistance can be used because of low manufacturing temperature. Therefore, the transistor can be formed using a light-transmitting substrate. Alternatively, transmission of light in a display element can be controlled by using the transistor formed using the light-transmitting substrate. Alternatively, part of a film included in the transistor can transmit light because of a small thickness of the transistor. Therefore, the aperture ratio can be improved.

Note that when a catalyst (e.g., nickel) is used in the case of forming polycrystalline silicon, crystallinity can be further improved and a transistor having excellent electric characteristics can be formed. Accordingly, a gate driver circuit (e.g., a scan line driver circuit), a source driver circuit (e.g., a signal line driver circuit), and a signal processing circuit (e.g., a signal generation circuit, a gamma correction circuit, or a DA converter circuit) can be formed using the same substrate.

Note that when a catalyst (e.g., nickel) is used in the case of forming microcrystalline silicon, crystallinity can be further improved and a transistor having excellent electric characteristics can be formed. In that case, crystallinity can be improved by just performing heat treatment without performing laser irradiation. Accordingly, a gate driver circuit (e.g., a scan line driver circuit) and part of a source driver circuit (e.g., an analog switch) can be formed over the same substrate. Note that when laser irradiation for crystallization is not performed, unevenness in crystallinity of silicon can be suppressed. Therefore, high-quality images can be displayed. Note that it is possible to form polycrystalline silicon or microcrystalline silicon without a catalyst (e.g., nickel).

Note that although the crystallinity of silicon is preferably improved to polycrystal, microcrystal, or the like in the whole panel, the present invention is not limited to this. The crystallinity of silicon may be improved only in part of the panel. Selective increase in crystallinity can be achieved by selective laser irradiation or the like. For example, only a peripheral circuit region excluding pixels may be irradiated with laser light. Alternatively, only a region of a gate driver circuit, a source driver circuit, or the like may be irradiated with laser light. Alternatively, only part of a source driver circuit (e.g., an analog switch) may be irradiated with laser light. Accordingly, the crystallinity of silicon can be improved only in a region in which a circuit needs to be operated at high speed. Because a pixel region is not particularly needed to be operated at high speed, even if crystallinity is not improved, the pixel circuit can be operated without any problem. Thus, a region whose crystallinity is improved is small, so that manufacturing steps can be decreased. This can increase throughput and reduce manufacturing cost. Alternatively, since the number of necessary manufacturing apparatus is small, manufacturing cost can be reduced.

Examples of the transistor include a transistor including a compound semiconductor (e.g., SiGe or GaAs) or an oxide semiconductor (e.g., ZnO, InGaZnO, indium zinc oxide (IZO), indium tin oxide (ITO), SnO, TiO, AlZnSnO (AZTO), or In—Sn—Zn—O (ITZO)) and a thin film transistor including a thin film of such a compound semiconductor or oxide semiconductor. Because manufacturing temperature can be lowered, such a transistor can be formed at room temperature, for example. The transistor can thus be formed directly on a substrate having low heat resistance, such as a plastic substrate or a film substrate. Note that such a compound semiconductor or an oxide semiconductor can be used not only for a channel portion of the transistor but also for other applications. For example, such a compound semiconductor or an oxide semiconductor can be used for a wiring, a resistor, a pixel electrode, a light-transmitting electrode, or the like. Such an element can be formed at the same time as the transistor; thus, cost can be reduced.

Note that for example, a transistor formed by an ink-jet method or a printing method can be used as a transistor. Accordingly, such a transistor can be formed at room temperature, can be formed at a low vacuum, or can be formed using a large substrate. Thus, the transistor can be formed without using a mask (reticle), which enables the layout of the transistor to be easily changed. Alternatively, the transistor can be formed without using a resist, leading to reductions in material cost and the number of steps. Further, a film can be formed only in a portion where the film is needed, a material is not wasted as compared with the case of employing a manufacturing method by which etching is performed after the film is formed over the entire surface, so that the cost can be reduced.

Note that for example, a transistor including an organic semiconductor or a carbon nanotube can be used as a transistor. Thus, such a transistor can be formed over a flexible substrate. A device including a transistor which includes an organic semiconductor or a carbon nanotube can resist a shock.

Note that transistors with a variety of different structures can be used for a transistor. For example, a MOS transistor, a junction transistor, a bipolar transistor, or the like can be used as a transistor. Since a MOS transistor has a small size, multiple transistors can be mounted. Note that a MOS transistor and a bipolar transistor may be formed over one substrate, in which case reductions in power consumption and size, high-speed operation, and the like can be achieved.

Note that in this specification and the like, for example, a transistor with a multi-gate structure having two or more gate electrodes can be used as a transistor. With the multi-gate structure, a structure where a plurality of transistors are connected in series is provided because channel regions are connected in series. Thus, with the multi-gate structure, the amount of off-state current can be reduced and the withstand voltage of the transistor can be increased (reliability can be improved). Alternatively, with the multi-gate structure, the drain-source current does not change so much even if the drain-source voltage fluctuates when the transistor operates in a saturation region, so that a flat slope of the voltage-current characteristics can be obtained. By utilizing the flat slope of the voltage-current characteristics, an ideal current source circuit or an active load having extremely high resistance can be obtained. Accordingly, a differential circuit, a current mirror circuit, or the like having excellent properties can be obtained.

Note that a transistor with a structure where gate electrodes are formed above and below a channel can be used, for example. With the structure where gate electrodes are formed above and below a channel, a circuit structure where a plurality of transistors are connected in parallel is provided. Thus, a channel region is increased, so that the amount of current can be increased. Alternatively, by using the structure where gate electrodes are formed above and below a channel, a depletion layer can be easily formed, resulting in lower subthreshold swing.

Note that for example, a transistor with a structure where a gate electrode is formed above a channel region, a structure where a gate electrode is formed below a channel region, a staggered structure, an inverted staggered structure, a structure where a channel region is divided into a plurality of regions, a structure where channel regions are connected in parallel or in series, or the like can be used as a transistor. A transistor with any of a variety of structures such as a planar type, a FIN-type, a Tri-Gate type, a top-gate type, a bottom-gate type, and a double-gate type (with gates above and below a channel) can be used.

Note that for example, a transistor with a structure where a source electrode or a drain electrode overlaps with a channel region (or part of it) can be used as a transistor. By using the structure where a source electrode or a drain electrode overlaps with a channel region (or part of it), unstable operation due to accumulation of electric charge in part of the channel region can be prevented.

Note that for example, a transistor with a structure where an LDD region is provided can be used as a transistor. Provision of the LDD region enables a reduction in off-current or an increase in the withstand voltage of the transistor (an improvement in reliability). Alternatively, by providing the LDD region, the drain current does not change so much even when the drain-source voltage fluctuates when the transistor operates in a saturation region, so that a flat slope of the voltage-current characteristics can be obtained.

Note that in this specification and the like, a transistor can be formed using any of a variety of substrates, for example. The type of a substrate is not limited to a certain type. Examples of the substrate are a semiconductor substrate (e.g., a single crystal substrate or a silicon substrate), an SOI substrate, a glass substrate, a quartz substrate, a plastic substrate, a metal substrate, a stainless steel substrate, a substrate including stainless steel foil, a tungsten substrate, a substrate including tungsten foil, a flexible substrate, an attachment film, paper including a fibrous material, and a base material film. Examples of the glass substrate are a barium borosilicate glass substrate, an aluminoborosilicate glass substrate, and a soda lime glass substrate. Examples of the flexible substrate, the attachment film, and the base material film are plastics typified by polyethylene terephthalate (PET), polyethylene naphthalate (PEN), and polyether sulfone (PES), a synthetic resin of acrylic or the like, polypropylene, polyester, polyvinyl fluoride, polyvinyl chloride, polyamide, polyimide, aramid, epoxy, an inorganic vapor deposition film, paper, and the like. Specifically, when a transistor is formed using a semiconductor substrate, a single crystal substrate, an SOI substrate, or the like, the transistor can have few variations in characteristics, size, shape, or the like, high current supply capability, and a small size. Formation a circuit with the use of such transistors leads to a reduction in power consumption of the circuit or high integration of the circuit.

Note that a transistor may be formed using a substrate, and then, the transistor may be transferred to another substrate. Example of a substrate to which a transistor is transferred are, in addition to the above substrate over which the transistor can be formed, a paper substrate, a cellophane substrate, an aramid substrate, a polyimide film substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), and the like), a leather substrate, and a rubber substrate. The use of such a substrate enables formation of a transistor with excellent properties, a transistor with low power consumption, or a device with high durability, high heat resistance, or a reduction in weight or thickness.

Note that all the circuits which are necessary to realize a desired function can be formed using one substrate (e.g., a glass substrate, a plastic substrate, a single crystal substrate, or an SOI substrate). In this manner, the cost can be reduced by a reduction in the number of components or reliability can be improved by a reduction in the number of connection points to circuit components.

Note that not all the circuits which are necessary to realize the predetermined function are needed to be formed using one substrate. That is, part of the circuits which are necessary to realize the predetermined function may be formed using a substrate and another part of the circuits which are necessary to realize the predetermined function may be formed using another substrate. For example, part of the circuits which are necessary to realize the predetermined function can be formed using a glass substrate and another part of the circuits which are necessary to realize the predetermined function can be formed using a single crystal substrate (or an SOI substrate). The single crystal substrate over which the another part of the circuits which are necessary to realize the predetermined function (such a substrate is also referred to as an IC chip) can be connected to the glass substrate by COG (chip on glass), and the IC chip can be provided over the glass substrate. Alternatively, the IC chip can be connected to the glass substrate by TAB (tape automated bonding), COF (chip on film), SMT (surface mount technology), a printed circuit board, or the like. When part of the circuits is formed over the same substrate as a pixel portion in this manner, the cost can be reduced by a reduction in the number of components or reliability can be improved by a reduction in the number of connection points between circuit components. In particular, a circuit in a portion where a driving voltage is high, a circuit in a portion where a driving frequency is high, or the like consumes much power in many cases. In view of the above, such a circuit is formed over a substrate (e.g., a single crystal substrate) different from a substrate over which a pixel portion is formed, whereby an IC chip is formed. The use of this IC chip allows prevention of increase in power consumption.

Note that contents that are not specified in any drawing or text in the specification can be excluded from the invention. Alternatively, when the range of a value that is defined by the maximum and minimum values is described, part of the range is appropriately narrowed and part of the range is removed, whereby the invention can be constituted excluding part of the range can be constructed. In this manner, it is possible to specify the technical scope of the present invention so that a conventional technology is excluded, for example.

As a specific example, a diagram of a circuit including first to fifth transistors is illustrated. In that case, it can be specified that the circuit does not include a sixth transistor in the invention. It can be specified that the circuit does not include a capacitor in the invention. It can be specified that the circuit does not include a sixth transistor with a particular connection structure in the invention. It can be specified that the circuit does not include a capacitor with a particular connection structure in the invention. For example, it can be specified that a sixth transistor whose gate is connected to a gate of the third transistor is not included in the invention. For example, it can be specified that a capacitor whose first electrode is connected to the gate of the third transistor is not included in the invention.

As another specific example, the description of a value, “a voltage is preferably higher than or equal to 3 V and lower than or equal to 10 V” is given. In that case, for example, it can be specified that the case where the voltage is higher than or equal to −2 V and lower than or equal to 1 V is excluded from the invention. For example, it can be specified that the case where the voltage is higher than or equal to 13 V is excluded from the invention. Note that, for example, it can be specified that the voltage is higher than or equal to 5 V and lower than or equal to 8 V in the invention. For example, it can be specified that the voltage is approximately 9 V in the invention. For example, it can be specified that the voltage is higher than or equal to 3 V and lower than or equal to 10 V but is not 9 V in the invention.

As another specific example, the description “a voltage is preferred to be 10 V” is given. In that case, for example, it can be specified that the case where the voltage is higher than or equal to −2 V and lower than or equal to 1 V is excluded from the invention. For example, it can be specified that the case where the voltage is higher than or equal to 13 V is excluded from the invention.

As another specific example, the description “a film is an insulating film” is given to describe a property of a material. In that case, for example, it can be specified that the case where the insulating film is an organic insulating film is excluded from the invention. For example, it can be specified that the case where the insulating film is an inorganic insulating film is excluded from the invention.

As another specific example, the description of a stacked structure, “a film is provided between A and B” is given. In that case, for example, it can be specified that the case where the film is a layered film of four or more layers is excluded from the invention. For example, it can be specified that the case where a conductive film is provided between A and the film is excluded from the invention.

Note that various people can implement the invention described in this specification and the like. However, different people may be involved in the implementation of the embodiment of the invention. For example, in the case of a transmission/reception system, the following case is possible: Company A manufactures and sells transmitting devices, and Company B manufactures and sells receiving devices. As another example, in the case of a light-emitting device including a TFT and a light-emitting element, the following case is possible: Company A manufactures and sells semiconductor devices including TFTs, and Company B purchases the semiconductor devices, provides light-emitting elements for the semiconductor devices, and completes light-emitting devices.

In such a case, one embodiment of the invention can be constituted so that a patent infringement can be claimed against each of Company A and Company B. In other words, one embodiment of the invention with which a patent infringement suit can be filed against Company A or Company B is clear and can be regarded as being disclosed in this specification or the like. For example, in the case of a transmission/reception system, one embodiment of the invention can be constituted by only the transmitting device and another embodiment of the invention can be constituted by only the receiving device. Those embodiments of the invention are clear and can be regarded as being disclosed in this specification or the like. Another example is as follows: in the case of a light-emitting device including a TFT and a light-emitting element, one embodiment of the invention can be constituted by only the semiconductor device including the TFT and another embodiment of the invention can be constituted by only the light-emitting device including the light-emitting element. Those embodiments of the invention are clear and can be regarded as being disclosed in this specification or the like.

Note that in this specification and the like, it may be possible for those skilled in the art to constitute one embodiment of the invention even when portions to which all the terminals of an active element (e.g., a transistor or a diode), a passive element (e.g., a capacitor or a resistor), are the like are connected are not specified. In other words, one embodiment of the invention is clear even when connection portions are not specified. Further, in the case where a connection portion is disclosed in this specification and the like, it can be determined that one embodiment of the invention in which a connection portion is not specified is disclosed in this specification and the like, in some cases. In particular, in the case where the number of portions to which the terminal is connected may be more than one, it is not necessary to specify the portions to which the terminal is connected. Therefore, it may be possible to constitute one embodiment of the invention by specifying only portions to which some of terminals of an active element (e.g., a transistor or a diode), a passive element (e.g., a capacitor or a resistor), and the like are connected.

Note that in this specification and the like, it may be possible for those skilled in the art to specify the invention when at least the connection portion of a circuit is specified. Alternatively, it may be possible for those skilled in the art to specify the invention when at least a function of a circuit is specified. In other words, when a function of a circuit is specified, one embodiment of the present invention is clear, and it can be determined that the embodiment is disclosed in this specification and the like. Therefore, when a connection portion of a circuit is specified, the circuit is disclosed as one embodiment of the invention even when a function is not specified, and one embodiment of the invention can be constituted. Alternatively, when a function of a circuit is specified, the circuit is disclosed as one embodiment of the invention even when a connection portion is not specified, and one embodiment of the invention can be constituted.

Note that in this specification and the like, part of a diagram or text described in one embodiment can be taken out to constitute one embodiment of the invention. Thus, in the case where a diagram or text related to a certain portion is described, the contents taken out from part of the diagram or the text are also disclosed as one embodiment of the invention, and one embodiment of the invention can be constituted. Therefore, for example, in a diagram or text in which one or more active elements (e.g., transistors or diodes), wirings, passive elements (e.g., capacitors or resistors), conductive layers, insulating layers, semiconductor layers, organic materials, inorganic materials, components, devices, operating methods, manufacturing methods, or the like are described, part of the diagram or the text is taken out, and one embodiment of the invention can be constituted. For example, from a circuit diagram in which N circuit elements (e.g., transistors or capacitors; N is an integer) are provided, it is possible to take out M circuit elements (e.g., transistors or capacitors; M is an integer, where M<N) and constitute one embodiment of the invention. For another example, it is possible to take out M layers (M is an integer, where M<N) from a cross-sectional view in which N layers (N is an integer) are provided and constitute one embodiment of the invention. For another example, it is possible to take out M elements (M is an integer, where M<N) from a flow chart in which N elements (N is an integer) are provided and constitute one embodiment of the invention.

Note that in the case where at least one specific example is described in a diagram or text described in one embodiment in this specification and the like, it will be readily appreciated by those skilled in the art that a broader concept of the specific example can be derived. Therefore, in the diagram or the text described in one embodiment, in the case where at least one specific example is described, a broader concept of the specific example is disclosed as one embodiment of the invention, and one embodiment of the invention can be constituted.

Note that in this specification and the like, what is illustrated in at least a diagram (which may be part of the diagram) is disclosed as one embodiment of the invention, and one embodiment of the invention can be constituted. Therefore, when certain contents are described in a diagram, the contents are disclosed as one embodiment of the invention even when the contents are not described with text, and one embodiment of the invention can be constituted. In a similar manner, part of a diagram, which is taken out from the diagram, is disclosed as one embodiment of the invention, and one embodiment of the invention can be constituted. The embodiment of the present invention is clear.

Note that the size, the thickness of layers, or regions in diagrams is sometimes exaggerated for simplicity. Therefore, embodiments of the present invention are not limited to such a scale.

In this specification, for example, when the shape of an object is described with use of a term such as “diameter”, “grain size”, “dimension”, “size”, or “width”, the term can be regarded as the length of one side of a minimal cube where the object fits, or an equivalent circle diameter of a cross section of the object. The term “equivalent circle diameter of a cross section of the object” refers to the diameter of a perfect circle having the same area as that of the cross section of the object.

Note that a “semiconductor” may have the characteristics of an “insulator” when the conductivity is sufficiently low, for example. In addition, a “semiconductor” and an “insulator” cannot be strictly distinguished from each other in some cases because a border between the “semiconductor” and the “insulator” is not clear. Accordingly, a “semiconductor” in this specification can be called an “insulator” in some cases. Similarly, an “insulator” in this specification can be called a “semiconductor” in some cases.

Note that a “semiconductor” may have the characteristics of a “conductor” when the conductivity is sufficiently high, for example. In addition, a “semiconductor” and a “conductor” cannot be strictly distinguished from each other in some cases because a border between the “semiconductor” and the “conductor” is not clear. Accordingly, a “semiconductor” in this specification can be called a “conductor” in some cases. Similarly, a “conductor” in this specification can be called a “semiconductor” in some cases.

Note that an impurity in a semiconductor film refers to, for example, elements other than the main components of a semiconductor film. For example, an element with a concentration of lower than 0.1 atomic % is an impurity. When an impurity is contained, carrier traps might be formed in the semiconductor film, the carrier mobility might be decreased, or the crystallinity might be decreased, for example. In the case where the semiconductor film is an oxide semiconductor film, examples of an impurity which changes the characteristics of the semiconductor film include Group 1 elements, Group 2 elements, Group 14 elements, Group 15 elements, and transition metals other than the main components; specifically, there are hydrogen (contained in water), lithium, sodium, silicon, boron, phosphorus, carbon, and nitrogen, for example. In the case where the semiconductor film is an oxide semiconductor film, oxygen vacancies might be formed by entry of an impurity. When the semiconductor film is a silicon film, examples of an impurity which changes the characteristics of the semiconductor film include oxygen, Group 1 elements except hydrogen, Group 2 elements, Group 13 elements, and Group 15 elements.

In this specification, excess oxygen refers to oxygen in excess of that in the stoichiometric composition, for example. Alternatively, excess oxygen refers to oxygen released by heating, for example. Excess oxygen can move inside a film or a layer. Excess oxygen moves between atoms in a film or a layer or excess oxygen replaces oxygen that is a constituent of a film or a layer and moves like a billiard ball. An insulating film containing excess oxygen means an insulating film from which oxygen is released by heat treatment, for example.

In this specification, the term “parallel” indicates that the angle formed between two straight lines is greater than or equal to −10° and less than or equal to 10°, and accordingly also includes the case where the angle is greater than or equal to −5° and less than or equal to 5°. In addition, a term “perpendicular” indicates that the angle formed between two straight lines is greater than or equal to 80° and less than or equal to 100°, and accordingly includes the case where the angle is greater than or equal to 85° and less than or equal to 95°.

In the embodiment, a conductive film may be formed using, for example, a single layer or a stack of a conductive film containing aluminum, titanium, chromium, cobalt, nickel, copper, yttrium, zirconium, molybdenum, ruthenium, silver, tantalum, or tungsten. As a light-transmitting conductive film, for example, an oxide film such as an In—Zn—W oxide film, an In—Sn oxide film, an In—Zn oxide film, an indium oxide film, a zinc oxide film, or a tin oxide film may be used. Furthermore, a slight amount of Al, Ga, Sb, F, or the like may be added to the above-described oxide film. Alternatively, a metal thin film having a thickness which enables light to be transmitted (preferably, approximately greater than or equal to 5 nm and less than or equal to 30 nm) may be used. For example, an Ag film, a Mg film, or an Ag—Mg alloy film with a thickness of 5 nm may be used. For example, as a film that reflects visible light efficiently, a film containing lithium, aluminum, titanium, magnesium, lanthanum, silver, silicon, or nickel can be used.

As an insulating film, for example, a single layer or a stack of an insulating film containing aluminum oxide, magnesium oxide, silicon oxide, silicon oxynitride, silicon nitride oxide, silicon nitride, gallium oxide, germanium oxide, yttrium oxide, zirconium oxide, lanthanum oxide, neodymium oxide, hafnium oxide, or tantalum oxide may be used. A resin film made of a polyimide resin, an acrylic resin, an epoxy resin, a silicone resin, or the like may be used as the insulating film.

In this specification, trigonal and rhombohedral crystal systems are included in a hexagonal crystal system.

In addition, terms such as “first”, “second”, and “third” in this specification are used in order to avoid confusion among components, and the terms do not limit the components numerically. Therefore, for example, the term “first” can be replaced with the term “second”, “third”, or the like as appropriate.

In this specification, in the case where an etching step is performed after a photolithography process, a mask formed in the photolithography process is removed after the etching step.

In some cases, a transistor is additionally provided with a second gate for applying a potential to a back channel. In such a case, to distinguish the two gates, the terminal that is generally called a gate is called a “front gate” and the other is called a “back gate” in this specification.

Note that “voltage” indicates a difference between the potentials of two points, and “potential” indicates electrostatic energy (electrical potential energy) of unit charge at a given point in an electrostatic field. Note that in general, a difference between a potential of one point and a reference potential (e.g., a ground potential) is merely called a potential or a voltage, and a potential and a voltage are used as synonymous words in many cases. Thus, in this specification, a potential may be replaced with a voltage and a voltage may be replaced with a potential unless otherwise specified.

In this specification and the like, “voltage” refers to a difference between a given potential and a reference potential (e.g., a ground potential) in many cases. Accordingly, the voltage, the potential, and the potential difference can also be referred to as a potential, a voltage, and a voltage difference, respectively.

Note that in general, a potential and a voltage are relative values. Therefore, a ground potential is not always 0 V.

A transistor is a kind of semiconductor elements and can achieve amplification of a current or a voltage, switching operation for controlling conduction or non-conduction, or the like. A transistor in this specification includes an insulated-gate field effect transistor (IGFET) and a thin film transistor (TFT).

For example, in this specification and the like, a transistor is an element having at least three terminals: a gate, a drain, and a source. The transistor includes a channel region between the drain (a drain terminal, a drain region, or a drain electrode) and the source (a source terminal, a source region, or a source electrode), and a current can flow through the drain, the channel region, and the source. Here, since the source and the drain of the transistor change depending on the structure, the operating condition, or the like of the transistor, it is difficult to define which is a source or a drain. Therefore, a portion functioning as a source or a drain is not called a source or a drain in some cases. In that case, for example, one of the source and the drain is referred to as a first terminal, a first electrode, or a first region, and the other of the source and the drain is referred to as a second terminal, a second electrode, or a second region in some cases.

For example, in this specification and the like, an explicit description “X and Y are connected” means that X and Y are electrically connected, X and Y are functionally connected, and X and Y are directly connected. Here, X and Y each denote an object (e.g., a device, an element, a circuit, a wiring, an electrode, a terminal, a conductive film, or a layer). Accordingly, without limitation to a predetermined connection relation, for example, a connection relation shown in drawings or text, another connection relation is included in the drawings or the text.

Examples of the case where X and Y are directly connected include the case where an element that allows an electrical connection between X and Y (e.g., a switch, a transistor, a capacitor, an inductor, a resistor, a diode, a display element, a light-emitting element, and a load) is not connected between X and Y, that is, the case where X and Y are connected without the element that allows the electrical connection between X and Y provided therebetween.

For example, in the case where X and Y are electrically connected, one or more elements that enable electrical connection between X and Y (e.g., a switch, a transistor, a capacitor, an inductor, a resistor, a diode, a display element, a light-emitting element, and a load) can be connected between X and Y. A switch is controlled to be on or off. That is, a switch is conducting or not conducting (is turned on or off) to determine whether a current flows therethrough or not. Alternatively, the switch has a function of selecting and changing a current path. Note that the case where X and Y are electrically connected includes the case where X and Y are directly connected.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power supply circuit (e.g., a step-up circuit and a step-down circuit) or a level shifter circuit for changing the potential level of a signal; a voltage source; a current source; a switching circuit; an amplifier circuit such as a circuit that can increase signal amplitude, the amount of current, or the like, an operational amplifier, a differential amplifier circuit, a source follower circuit, or a buffer circuit; a signal generation circuit; a memory circuit; and/or a control circuit) can be connected between X and Y. Note that for example, in the case where a signal output from Xis transmitted to Y even when another circuit is interposed between X and Y, X and Y are functionally connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the description “X and Y are connected”.

Note that, for example, the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to a part of Z1 and another part of Z1 is directly connected to X while a drain (or a second terminal or the like) of the transistor is directly connected to a part of Z2 and another part of Z2 is directly connected to Y, can be expressed by using any of the following expressions.

The expressions include, for example, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path”. Other examples of the expressions also include “a source (or a first terminal or the like) of a transistor is electrically connected to X through at least Z1 on a first connection path, the first connection path does not include a second connection path, the second connection path includes a connection path through the transistor, a drain (or a second terminal or the like) of the transistor is electrically connected to Y through at least Z2 on a third connection path, and the third connection path does not include the second connection path”, and “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit configuration is defined by an expression similar to the above examples, a source (or a first terminal or the like) and a drain (or a second terminal or the like) of a transistor can be distinguished from each other to specify the technical scope.

Note that these expressions are only examples and one embodiment of the present invention is not limited to the expressions. Here, X, Y, Z1, and Z2 each denote an object (e.g., a device, an element, a circuit, a wiring, an electrode, a terminal, a conductive film, and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

For example, in this specification and the like, when it is explicitly described that Y is formed on or over X, it does not necessarily mean that Y is formed over and in direct contact with X. The description includes the case where X and Y are not in direct contact with each other, i.e., the case where another object is interposed between X and Y. Here, X and Y each denote an object (e.g., a device, an element, a circuit, a line, an electrode, a terminal, a conductive film, or a layer).

Therefore, for example, when it is explicitly described that “a layer Y is formed on (or over) a layer X”, it includes both the case where the layer Y is formed over and in direct contact with the layer X, and the case where another layer (e.g., a layer Z) is formed over and in direct contact with the layer X and the layer Y is formed over and in direct contact with the layer Z. Note that another layer (e.g., a layer Z) may be a single layer or a plurality of layers (a stack of layers).

In a similar manner, when it is explicitly described that “Y is formed above X”, it does not necessarily mean that Y is formed in direct contact with X, and another object may be interposed therebetween. Therefore, for example, when it is described that “a layer Y is formed above a layer X”, it includes both the case where the layer Y is formed over and in direct contact with the layer X, and the case where another layer (e.g., a layer Z) is formed over and in direct contact with the layer X and the layer Y is formed over and in direct contact with the layer Z. Note that another layer (e.g., a layer Z) may be a single layer or a plurality of layers (a stack of layers).

Note that when it is explicitly described that “Y is formed on X”, “Y is formed over X”, or “Y is formed above X”, it includes the case where Y is formed obliquely over/above X.

Note that, similarly, when it is described that “Y is formed under X” or “Y is formed below X”, it includes the case where Y is formed obliquely under/below X.

For example, in this specification and the like, terms for describing spatial arrangement, such as “over”, “above”, “under”, “below”, “laterally”, “right”, “left”, “obliquely”, “behind”, “front”, “inside”, “outside”, and “in” are often used for briefly showing a relation between an element and another element or between a feature and another feature with reference to a diagram. Note that the embodiments of the present invention are not limited to this, and such terms for describing spatial arrangement can indicate not only the direction illustrated in a diagram but also another direction. For example, when it is explicitly described that “Y is over X”, it does not necessarily mean that Y is placed over X Since a device in a diagram can be inverted or rotated by 180°, the case where Y is placed under X can be included. Accordingly, “over” can refer to the direction described by “under” in addition to the direction described by “over”. Note that the embodiments of the present invention are not limited to this, and “over” can refer to any of the other directions described by “laterally”, “right”, “left”, “obliquely”, “behind”, “front”, “inside”, “outside”, and “in” in addition to the directions described by “over” and “under” because the device in the diagram can be rotated in a variety of directions. That is, the terms for describing spatial arrangement can be construed adequately depending on the situation.

This embodiment is obtained by performing change, addition, modification, removal, application, superordinate conceptualization, or subordinate conceptualization on part or the whole of any of the other embodiments. Thus, part or the whole of this embodiment can be freely combined with, applied to, or replaced with part or the whole of any of the other embodiments.

This application is based on Japanese Patent Application serial No. 2013-255042 filed with the Japan Patent Office on Dec. 10, 2013, the entire contents of which are hereby incorporated by reference.

What is claimed is:

1. An electronic device comprising:
a first region and a second region,
wherein the first region is configured to display an image of a subject, and to illuminate the subject with light while keeping a state of displaying the image of the subject,
wherein the second region is configured to display with substantially even luminance, and to illuminate the subject with light using an entire area of the second region, and
wherein a direction of light illuminated from the first region to the subject is different from a direction of light illuminated from the second region to the subject.

2. An electronic device comprising:
a first region and a second region,
wherein the first region is configured to display an image of a subject, and to illuminate the subject with flash light while keeping a state of displaying the image of the subject,
wherein the second region is configured to display with substantially even luminance, and to illuminate the subject with flash light using an entire area of the second region, and
wherein a direction of light illuminated from the first region to the subject is different from a direction of light illuminated from the second region to the subject.
